(19) United States
(12) Patent Application Publication
(10) Pub. No.: US 2015/0355763 A1
(43) Pub. Date: Dec. 10, 2015

(54) SENSOR, INPUT DEVICE, AND INPUT/OUTPUT DEVICE

(71) Applicant: SEMICONDUCTOR ENERGY LABORATORY CO., LTD., Atsugi-shi (JP)

(72) Inventors: Hiroyuki MIYAKE, Atsugi (JP); Kazunori WATANABE, Atsugi (JP)

(21) Appl. No.: 14/638,649

(22) Filed: Apr. 30, 2015

(30) Foreign Application Priority Data
Mar. 7, 2014 (JP) 2014-045249

(51) Int. Cl. G06F 3/041; G06F 1/16; G06F 3/044

(52) U.S. Cl. CPC G06F 3/0412; G06F 3/044; G06F 1/16; G06F 3/0416; G06F 2203/04102

(57) ABSTRACT

[Problem] A novel input sensor that is highly convenient or reliable is provided. Furthermore, a novel input device that is highly convenient or reliable is provided. Furthermore, a novel input/output device that is highly convenient or reliable is provided.

[Solution] The following structure including a window portion which transmits visible light, a light-transmitting sensor element which includes a flexible insulating layer and a pair of electrodes, between which it is interposed, and overlaps with the window portions, a sensing circuit which supplies a sensor signal on the basis of a change in the capacitance of the sensor element, and a flexible base layer supporting the sensor element and the sensor circuit is achieved.

### FIELD OF THE INVENTION

One embodiment of the present invention relates to a sensor, an input device, or an input/output device.

Note that one embodiment of the present invention is not limited to the above technical field. The technical field of one embodiment of the invention disclosed in this specification and the like relates to an object, a method, or a manufacturing method. In addition, one embodiment of the present invention relates to a process, a machine, manufacture, or a composition of matter. Specifically, examples of the technical field of one embodiment of the present invention disclosed in this specification include a semiconductor device, a display device, a light-emitting device, a power storage device, a memory device, a method of driving any of them, and a method of manufacturing any of them.

### PRIOR ART

The social infrastructures relating to means for transmitting data have advanced. This has made it possible to acquire, process, and send out various kinds and plenty of data with the use of a data processing device not only at home or office but also at other visiting places.

With this being the situation, portable data processing devices are under active development.

For example, a data processing device is often used while being carried around, and force might be accidentally applied by dropping to the data processing device and a display device used in it. As an example of a display device that is not easily broken, a display device having high adhesiveness between a structure body by which a light-emitting layers are partitioned and a second electrode layer is known (Patent Document 1).

For example, a cellular phone in which a display device is placed on the front face of a housing and on the upper portion in the longitudinal direction is known (Patent Document 2).

### REFERENCES

### Patent Documents

[Patent Document 1] Japanese Published Patent Application No. 2012-190794
[Patent Document 2] Japanese Published Patent Application No. 2010-153813

### SUMMARY OF THE INVENTION

### Problems to be Solved by the Invention

An object of one embodiment of the present invention is to provide a novel sensor that is highly convenient or reliable. Alternatively, an object is to provide a novel input device that is highly convenient or reliable. Alternatively, an object is to provide a novel input/output device that is highly convenient or reliable. Alternatively, an object is to provide a novel sensor, a novel input device, a novel input/output device, or a novel semiconductor device.

Note that the descriptions of these objects do not preclude the existence of other objects. In one embodiment of the present invention, there is no need to achieve all the objects. Other objects will be apparent from and can be derived from the description of the specification, the drawings, the claims, and the like.

### Means for Solving the Problems

One embodiment of the present invention includes a window portion transmitting visible light, a sensor element having a light transmitting property and overlapping with the window portion, a sensor circuit electrically connected to the sensor element, and a flexible base layer supporting the sensor element and the sensor circuit.

In addition, in the sensor, the sensor element comprises a flexible insulating layer, and a first electrode and a second electrode between which the insulating layer is interposed, and the sensor circuit supplies a sensor signal on the basis of a change in the capacitance of the sensor element.

Furthermore, one embodiment of the present invention is the above sensor in which the sensor element contains a silicone gel in the insulating layer and can be folded at a radius of curvature greater than or equal to 1 mm.

Furthermore, one embodiment of the present invention is the above sensor in which the sensor circuit comprises a first transistor comprising a gate electrically connected to the first electrode of the sensor element and a first electrode electrically connected to a wiring through which a ground potential can be supplied, a first switch comprising a control terminal electrically connected to a wiring through which a selection signal can be supplied, a first terminal electrically connected to a second electrode of the first transistor, and a second terminal electrically connected to a wiring through which the sensor signal can be supplied, and a second switch comprising a control terminal electrically connected to a wiring through which a reset signal can be supplied, a first terminal electrically connected to the first electrode of the sensor element, and a second terminal electrically connected to the wiring through which the ground potential can be supplied.

The above sensor of one embodiment of the present invention includes the window portion which transmits visible light, the light-transmitting sensor element which includes the flexible insulating layer and a pair of electrodes, between which it is interposed, and overlaps with the window portion, the sensor circuit which supplies the sensor signal on the basis of a change in the capacitance of the sensor element, and the flexible base layer supporting the sensor element and the sensor circuit.

Note that the capacitance of the sensor element is changed when an object gets close to the first electrode or the second electrode or when a distance between the first electrode and the second electrode is changed, for example. Thus, the sensor can supply the sensor signal based on the change in the capacitance of the sensor element, can transmit visible light, and can be bent. Consequently, a novel sensor that is highly convenient or reliable can be provided.

Furthermore, one embodiment of the present invention includes a plurality of sensor units arranged in a matrix, scan lines to which the plurality of sensor units placed along a row direction are electrically connected, signal lines to which the plurality of sensor units placed along a column direction are electrically connected, and a flexible base layer provided with the sensor units, the scan lines, and the signal lines.

In addition, in the input device, the sensor unit comprises a window portion transmitting visible light, a sensor element overlapping with the window portion, and a sensor circuit electrically connected to the sensor element; the sensor element comprises a flexible insulating layer, and a first electrode and a second electrode between which the insulating layer is interposed; the sensor circuit is supplied with a selection signal and supplies a sensor signal on the basis of a change in the capacitance of the sensor element; the selection signal can be supplied through the scan lines; and the signal lines can be supplied with the sensor signal.

Furthermore, one embodiment of the present invention is the above input device in which the sensor element contains a silicone gel in the insulating layer and can be folded at a radius of curvature greater than or equal to 1 mm.

Furthermore, one embodiment of the present invention is the above input device in which the sensor circuit comprises a first transistor comprising a gate electrically connected to the first electrode of the sensor element and a first electrode electrically connected to a wiring through which a ground potential can be supplied, a first switch comprising a control terminal electrically connected to a wiring through which the selection signal can be supplied, a first terminal electrically connected to a second electrode of the first transistor, and a second terminal electrically connected to a wiring through which the sensor signal can be supplied, and a second switch comprising a control terminal electrically connected to a wiring through which a reset signal can be supplied, a first terminal electrically connected to the first electrode of the sensor element, and a second terminal electrically connected to the wiring through which the ground potential can be supplied.

The above input device of one embodiment of the present invention includes sensor units which include the window portions which transmit visible light, the light-transmitting sensor elements which include the flexible insulating layer and a pair of electrodes between which it is interposed and overlap with the window portions, the sensor circuits which supply the sensor signal on the basis of a change in the capacitance of the sensor element and are arranged in a matrix, and the flexible base layer supporting the sensor units.

Note that the capacitance of the sensor element is changed when an object gets close to the first electrode or the second electrode or when a distance between the first electrode and the second electrode is changed, for example. Thus, the input device can supply the positional data of a sensor unit and the sensor signal detected by the sensor unit, can transmit visible light, and can be bent. Consequently, a novel input device that is highly convenient or reliable can be provided.

Furthermore, one embodiment of the present invention is the above input device in which an area of the second electrode of the sensor element is 10 times or more as large as a sum of the areas of the first electrodes included in the plurality of sensor elements electrically connected to one signal line.

In the above input device of one embodiment of the present invention, one sensor unit can be selected from the plurality of sensor units connected to one signal line by using the selection signal, and the first electrode having a sufficiently smaller area than the second electrode is included.

Thus, the capacitance derived from the sensor unit that is selected can be separated from the capacitance derived from the sensor unit that is not selected. Furthermore, a sensor unit whose first electrode has a small area is placed, so that positional data can be acquired in detail. Consequently, a novel input device that is highly convenient or reliable can be provided.

One embodiment of the present invention includes an input device including a plurality of sensor units which include window portions transmitting visible light and are arranged in a matrix, scan lines to which the plurality of sensor units placed along the row direction are electrically connected, signal lines to which the plurality of sensor units placed along the column direction are electrically connected, and a first flexible base layer supporting the plurality of sensor units, the scan lines, and the signal lines; and includes a display portion including a plurality of pixels that are arranged in a matrix and overlap with the window portions and a second flexible base layer supporting the pixels.

In addition, in the input/output device, the sensor unit comprises a window portion transmitting visible light, a sensor element overlapping with the window portion, and a sensor circuit electrically connected to the sensor element; the sensor element comprises a flexible insulating layer, and a first electrode and a second electrode between which the insulating layer is interposed; the sensor circuit is supplied with a selection signal and supplies a sensor signal on the basis of a change in the capacitance of the sensor element; the selection signal can be supplied through the scan lines; the sensor signal can be supplied through the signal lines; and the sensor circuit is placed so as to overlap with gaps between the window portions.

One embodiment of the present invention is the above-described input/output device including a coloring layer between the sensor unit and the pixel.

The above input/output device of one embodiment of the present invention includes a flexible input device including the plurality of sensor units provided with the window portions which transmit visible light, the flexible display portion including the plurality of pixels overlapping with the window portions, and the coloring layer between the window portion and the pixel.

Thus, the input/output device can supply a sensor signal based on a change in capacitance and the positional data of the sensor unit that supplies the sensor signal, can display image data associated with the positional data of the sensor unit, and can be bent. As a result, a novel input/output device that is highly convenient or reliable can be provided.

Note that in this specification, an EL layer refers to a layer provided between a pair of electrodes in a light-emitting element. Thus, a light-emitting layer containing an organic compound that is a light-emitting substance which is interposed between electrodes is an embodiment of the EL layer.

In this specification, in the case where a substance A is dispersed in a matrix formed using a substance B, the substance B forming the matrix is referred to as host material, and the substance A dispersed in the matrix is referred to as guest material. Note that the substance A and the substance B may each be a single substance or a mixture of two or more kinds of substances.

Note that a light-emitting device in this specification means an image display device or a light source (including a lighting device). In addition, the light-emitting device includes any of the following modules in its category: a module in which a connector such as an FPC (Flexible printed circuit) or a TCP (Tape Carrier Package) is attached to a light-emitting device; a module having a TCP provided with a printed wiring board at the end thereof; and a module having an IC (integrated circuit) directly mounted on a substrate over which a light-emitting element is formed by a COG (Chip On Glass) method.

In a block diagram attached to this specification, components are classified according to their functions and shown as independent blocks; however, it is practically difficult to completely separate the components according to their functions, and one component may have a plurality of functions.

In this specification, the terms source and drain of a transistor interchange with each other depending on the polarity of the transistor or the levels of potentials applied to the terminals. In general, in an n-channel transistor, a terminal to which a lower potential is applied is called a source, and a terminal to which a higher potential is applied is called a drain. Furthermore, in a p-channel transistor, a terminal to which a lower potential is applied is called a drain, and a terminal to which a higher potential is applied is called a source. In this specification, although connection relationship of a transistor is described assuming that the source and the drain are fixed in some cases for convenience, actually, the names of the source and the drain interchange with each other depending on the relation of the potentials.

In this specification, the term source of a transistor means a source region that is part of a semiconductor film functioning as an active layer or a source electrode connected to the semiconductor film. Similarly, the term drain of a transistor means a drain region that is part of the semiconductor film or a drain electrode connected to the semiconductor film. In addition, the term gate means a gate electrode.

In this specification, a state in which transistors are connected in series means, for example, a state in which only one of a source and a drain of a first transistor is connected to only one of a source and a drain of a second transistor. In addition, a state in which transistors are connected in parallel means a state in which one of a source and a drain of a first transistor is connected to one of a source and a drain of a second transistor and the other of the source and the drain of the first transistor is connected to the other of the source and the drain of the second transistor.

The term connection in this specification means electrical connection and corresponds to the case of a structure in which current, voltage, or potential can be supplied or transmitted. Therefore, a circuit configuration in which connection is made does not necessarily refer to a state of direct connection, and also includes, in its category, a circuit configuration in which connection is indirectly made through a circuit element such as a wiring, a resistor, a diode, or a transistor so that current, voltage and potential can be supplied or transmitted.

In this specification, even when different components are connected to each other in a circuit diagram, there is actually a case where one conductive film has functions of a plurality of components such as a case where part of a wiring serves as an electrode. The term connection in this specification also means such a case where one conductive film has functions of a plurality of components.

Furthermore, in this specification, one of a first electrode and a second electrode of a transistor refers to a source electrode and the other refers to a drain electrode.

According to one embodiment of the present invention, a novel sensor that is highly convenient or reliable can be provided. Alternatively, a novel input device that is highly convenient or reliable can be provided. A novel input/output device that is highly convenient or reliable can be provided. Alternatively, a novel sensor, a novel input device, a novel input/output device, or a novel semiconductor device can be provided. Note that the descriptions of these effects do not preclude the existence of other effects. One embodiment of the present invention does not necessarily have all the effects listed above. Other effects will be apparent from and can be derived from the description of the specification, the drawings, the claims, and the like.

### BRIEF DESCRIPTION OF THE DRAWINGS

FIGS. 1A-1C Schematic views and a circuit diagram illustrating a structure of a sensor according to an embodiment.

FIGS. 2A-2D Diagrams illustrating a structure of a sensor according to an embodiment.

FIGS. 3A-3B2 A circuit diagram illustrating a structure of a sensor and timing charts illustrating a driving method according to an embodiment.

FIGS. 4A-4B Diagrams illustrating a structure of an input device according to an embodiment.

FIGS. 5A-5B3 A block diagram illustrating a structure of an input device and timing charts illustrating a driving method according to an embodiment.

FIGS. 6A-6C Projection views illustrating a structure of an input device according to an embodiment.

FIGS. 7A-7C Cross-sectional views illustrating structures of an input device according to an embodiment.

FIGS. 8A-8C Projection views illustrating a structure of a data processing device according to an embodiment.

FIGS. 9A-9C Diagrams illustrating a structure of a transistor that can be used in a sensor circuit according to an embodiment.

FIGS. 10A1-10E2 Schematic views illustrating a manufacturing process of a stack according to an embodiment.

FIGS. 11A1-11E2 Schematic views illustrating a manufacturing process of a stack according to an embodiment.

FIGS. 12A1-12E2 Schematic views illustrating a manufacturing process of a stack according to an embodiment.

FIGS. 13A1-13D2 Schematic views illustrating manufacturing processes of stacks including an opening portion in a support according to an embodiment.

FIGS. 14A1-14B2 Schematic views illustrating structures of processed members according to an embodiment.

### EMBODIMENTS OF THE INVENTION

The sensor of one embodiment of the present invention includes the window portion which transmits visible light, the light-transmitting sensor element which includes the flexible insulating layer and a pair of electrodes between which it is interposed and overlaps with the window portion, the sensor circuit which supplies the sensor signal on the basis of a change in the capacitance of the sensor element, and the flexible base layer supporting the sensor element and the sensor circuit.

Thus, the sensor can supply the sensor signal based on the change in the capacitance of the sensor element, can transmit visible light, and can be bent. Consequently, a sensor, an input device, or an input/output device which is novel and highly convenient or reliable can be provided.

Embodiments will be described in detail with reference to the accompanying drawings. Note that the present invention is not limited to the description below, and it is easily understood by those skilled in the art that various changes and modifications can be made without departing from the spirit and scope of the present invention. Therefore, the present invention should not be construed as being limited to the description in the following embodiments. Note that in the structures of the invention described below, the same portions or portions having similar functions are denoted by the same reference numerals in different drawings, and description of such portions is not repeated.

### Embodiment 1

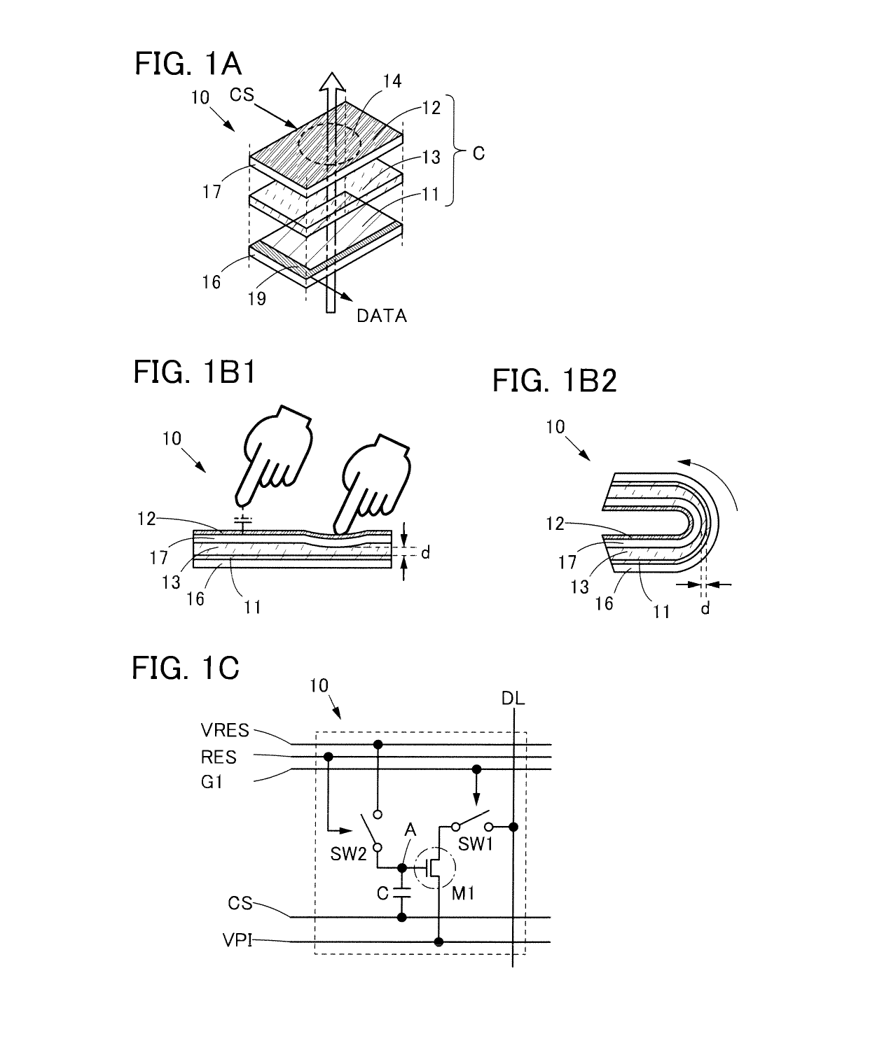

In this embodiment, a structure of a sensor of one embodiment of the present invention is described with reference to FIG. 1 to FIG. 3.

FIG. 1 illustrates a structure of a sensor 10 of one embodiment of the present invention.

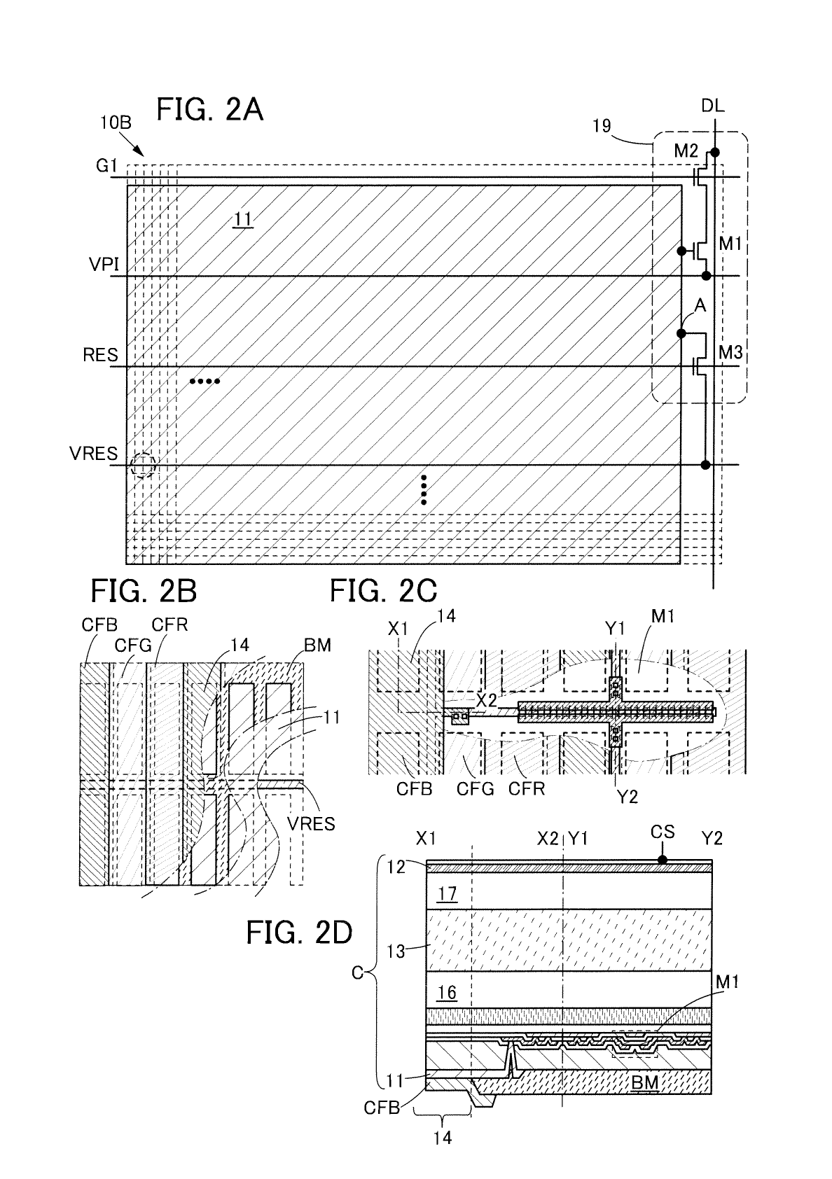

FIG. 2 illustrates a structure of a sensor 10B of one embodiment of the present invention.

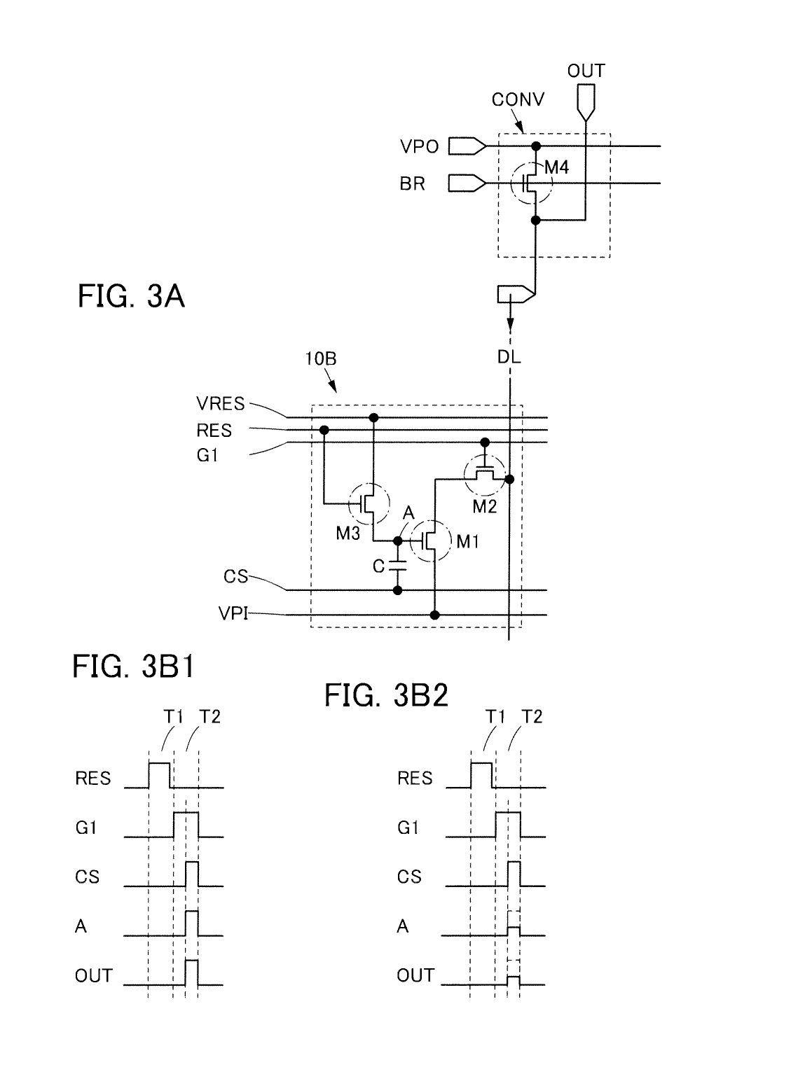

FIG. 3 illustrates a driving method of the sensor 10B of one embodiment of the present invention.

FIG. 1(A) is a schematic view illustrating the structure of the sensor 10 of one embodiment of the present invention.

FIG. 1(B-1) and FIG. 1(B-2) are schematic views illustrating a state in which the capacitance of the sensor 10 is changed.

FIG. 1(C) is a circuit diagram illustrating an example of a structure of a sensor circuit that can be used in the sensor 10.

### <Structure Example 1 of Sensor

The sensor 10 described in this embodiment includes a window portion 14 transmitting visible light, a sensor element C overlapping with the window portion 14, a sensor circuit 19 electrically connected to the sensor element C, and a flexible base layer 16 supporting the sensor element C and the sensor circuit 19 (see FIG. 1(A)).

In addition, the sensor element C includes a flexible insulating layer 13, and a first electrode 11 and a second electrode 12 between which the insulating layer 13 is interposed.

The sensor circuit 19 supplies a sensor signal DATA on the basis of a change in the capacitance of the sensor element C.

Furthermore, the sensor 10 may have a structure in which the insulating layer 13 of the sensor element C contains a silicone gel and it can be folded at a radius of curvature of 4 mm or more, preferably 2 mm or more, more preferably 1 mm or more, repeatedly a hundred times or more, preferably a thousand times or more, more preferably a ten thousand times or more, further preferably a hundred thousand times or more (see FIG. 1(B-2)).

Furthermore, the sensor circuit 19 may have a structure in which it includes a first transistor M1 comprising a gate electrically connected to the first electrode 11 of the sensor element C and a first electrode electrically connected to a wiring VPI through which, for example, a ground potential can be supplied (see FIG. 1(C)).

Furthermore, the structure may include a first switch SW1 comprising a control terminal electrically connected to a scan line G1 through which a selection signal can be supplied, a first terminal electrically connected to a second electrode of the first transistor M1, and a second terminal electrically connected to, for example, a signal line DL through which the sensor signal DATA can be supplied.

Furthermore, the structure may include a second switch SW2 comprising a control terminal electrically connected to a wiring RES through which a reset signal can be supplied, a first terminal electrically connected to the first electrode 11 of the sensor element C, and a second terminal electrically connected to, for example, a wiring VRES through which the ground potential can be supplied.

The sensor 10 described in this embodiment includes the window portion 14 which transmits visible light, the light-transmitting sensor element C which includes the flexible insulating layer 13 and the pair of electrodes, between which it is interposed, and overlaps with the window portion 14, the sensor circuit 19 which supplies the sensor signal DATA on the basis of a change in the capacitance of the sensor element C, and the flexible base layer 16 supporting the sensor element C and the sensor circuit 19.

Note that the capacitance of the sensor element C is changed when an object gets close to the first electrode 11 or the second electrode 12 or when a distance d between the first electrode 11 and the second electrode 12 is changed, for example (see FIG. 1(B-1)). Thus, the sensor 10 can supply the sensor signal DATA based on the change in the capacitance of the sensor element C, can transmit visible light, and can be bent. Consequently, a novel sensor that is highly convenient or reliable can be provided.

Furthermore, the sensor 10 can include a wiring CS which is electrically connected to the second electrode 12 of the sensor element C and through which a control signal capable of controlling the potential of the second electrode of the sensor element C, the signal line DL which is electrically connected to the sensor circuit 19 and can be supplied with the sensor signal DATA, or a flexible base layer 17 which supports the second electrode 12.

Note that a nodal portion where the first electrode 11 of the sensor 10, the gate of the first transistor M1, and the first terminal of the second switch SW2 are electrically connected is referred to as node A.

Individual components included in the sensor 10 are described below. Note that these units cannot be clearly distinguished and one unit also serves as another unit or include part of another unit in some cases.

For example, a support having an insulating property and flexibility and supporting the second electrode 12 serves not only as the insulating layer 13 but also as the base layer 17.

### <Overall Structure>

The sensor 10 includes the window portion 14, the sensor element C, the sensor circuit 19, and the base layer 16.

Furthermore, the base layer 17, the signal line DL, the wiring VPI, the wiring CS, the scan line G1, the wiring RES, the wiring VRES, and the signal line DL may be included.

### <<Window Portion 14>>

The window portion 14 transmits visible light. Through this, a user of the sensor 10 on one side can view an object on the other side. For example, from one side of the sensor 10, image data displayed on the display device placed on the other side can be viewed.

For example, the window portion 14 is formed in such a manner that the base layer 16, the first electrode 11, the insulating layer 13 having flexibility, the base layer 17, and the second electrode 12 which use a material transmitting visible light or a material thin enough to transmit visible light are placed to overlap so as not to prevent transmission of visible light (see FIG. 1(A)).

For example, an opening portion may be provided in a material that does not transmit visible light and used. Specifically, one or more opening portions having a variety of shapes such as a rectangle may be provided and used.

### <<Sensor Element C>>

The sensor element C includes the first electrode 11, the second electrode 12, and the insulating layer 13 having flexibility.

The second electrode 12 is placed so as to form a capacitor with the first electrode 11. For example, the second electrode 12 may be placed so as to overlap with the first electrode 11, and the second electrode 12 may be placed so as to be aligned with the first electrode 11.

For example, the sensor element C illustrated in FIG. 1(A) includes the first electrode 11 and the second electrode 12 overlapping with the first electrode 11.

For example, when an object whose dielectric constant is different from that of the air gets close to the first electrode 11 or the second electrode 12 of the sensor element C placed in the air, the capacitance of the sensor element C is changed. Specifically, when a finger or the like gets close to the sensor element C, the capacitance of the sensor element C is changed (see the left in FIG. 1(B-1)). Thus, the use as a proximity sensor is possible.

For example, the capacitance of the sensor element C which can change its shape varies with the change in shape.

Specifically, when a finger or the like touches the sensor element C, and the distance d between the first electrode 11 and the second electrode 12 becomes small, the capacitance of the sensor element C is increased (see the right in FIG. 1(B-1)). Thus, the use as a contact sensor is possible. As a result, writing pressure can be sensed.

Specifically, in the case where the insulating layer 13 having flexibility is included such that the sensor element C can be folded, by folding the sensor element C, the insulating layer 13 having flexibility is compressed and the distance d between the first electrode 11 and the second electrode 12 becomes small. Consequently, the capacitance of the sensor element C is increased (see FIG. 1(B-2)). Thus, the use as a folding sensor is possible.

The first electrode 11 and the second electrode 12 include a conductive material.

For example, an inorganic conductive material, an organic conductive material, metal or conductive ceramic, or the like can be used for the first electrode 11 and the second electrode 12.

Specifically, a metal element selected from aluminum, chromium, copper, tantalum, titanium, molybdenum, tungsten, nickel, silver, and manganese, an alloy containing the above-described metal element, an alloy containing any of the above-described metal elements in combination, or the like can be used.

Specifically, a conductive oxide such as indium oxide, indium tin oxide, indium zinc oxide, zinc oxide, or zinc oxide to which gallium is added can be used.

Specifically, graphene or graphite can be used.

Specifically, a conductive high molecule can be used.

### <<Insulating Layer 13>>

The insulating layer 13 has a high volume resistivity, for example, a volume resistivity of 1×10¹⁴ or more, preferably 2×10¹⁴ or more, more preferably 4×10¹⁴ or more.

A material having a thickness greater than or equal to 10 μm and less than or equal to 3000 preferably greater than or equal to 10 μm and less than or equal to 1000μ can be used for the insulating layer 13.

The insulating layer 13 has flexibility. For example, it has a Young's modulus of 50 KPa or less, preferably 30 KPa or less, more preferably 15 KPa or less. Furthermore, it has a 1/10-mm penetration of 100 or more, preferably 150 or more, more preferably 200 or more. In addition, it has an elongation of 250% or more, preferably 340% or more, more preferably 380% or more.

An elastic body can be used for the insulating layer 13. For example, silicone gel or silicone gel containing low molecular siloxane can be used.

### <<Sensor Circuit 19>>

The sensor circuit 19 includes the transistor M1, the first switch SW1, and the second switch SW2. The sensor circuit 19 also includes wirings through which a power supply potential and a signal are supplied. For example, the signal line DL, the wiring VPI, the wiring CS, the scan line G1, the wiring RES, the wiring VRES, the signal line DL, and the like are included.

Note that the sensor circuit 19 may be placed in a region not overlapping with the window portion 14. For example, the wirings are placed in a region not overlapping with the window portions 14, so that an object on one side of the sensor 10 can be easily viewed from the other side.

For example, a transistor that can be formed in the same process as the transistor M1 can be used as the first switch SW1 and the second switch SW2.

The transistor M1 includes a semiconductor layer. For example, for the semiconductor layer, a group 4 element, a compound semiconductor, or an oxide semiconductor can be used. Specifically, a semiconductor containing silicon, a semiconductor containing gallium arsenide, an oxide semiconductor containing indium, or the like can be used.

A structure of a transistor in which an oxide semiconductor is used for a semiconductor layer is described in detail in Embodiment 5.

For the wiring, a conductive material can be used.

For example, an inorganic conductive material, an organic conductive material, metal or conductive ceramic, or the like can be used for the wiring. Specifically, a material that can be used for the first electrode 11 and the second electrode 12 can be used.

The base layer 16 may be provided with the sensor circuit 19 by processing a film formed on the base layer 16.

Alternatively, the sensor circuit 19 may be formed on another base layer so that the sensor circuit 19 formed on another base layer is transferred to the base layer 16.

Note that a manufacturing method of the sensor 10 including the sensor circuit 19 is described in detail in Embodiment 6.

### <<Base Layer 16>>

For the flexible base layer 16, an organic material, an inorganic material, or a composite material of an organic material and an inorganic material can be used.

For the base layer 16, a material with a thickness greater than or equal to 5 μm and less than or equal to 2500 μm, preferably less than or equal to 5 μm and less than or equal to 680 μm, further preferably greater than or equal to 5 μm and less than or equal to 170 μm, further preferably greater than or equal to 5 μm and less than or equal to 45 μm, further preferably greater than or equal to 8 μm and less than or equal to 25 μm can be used.

A material with which passage of impurities is inhibited can be preferably used for the base layer 16. For example, a material with a vapor permeability less than or equal to 10⁻⁵ g/(m²·day), preferably less than or equal to 10⁻⁶ g/(m²·day) can be favorably used.

Preferably, materials having substantially equal coefficients of linear expansion can be used for the base layer 16. For example, a material having a coefficient of linear expansion less than or equal to 1×10⁻³/K, further preferably less than or equal to 5×10⁻⁵/K, and still further preferably less than or equal to 1×10⁻⁵/K can preferably be used.

For example, an organic material such as a resin, a resin film, or a plastic film can be used as the base layer 16.

For example, an inorganic material such as a metal plate or a thin sheet-like glass plate with a thickness greater than or equal to 10 μm and less than or equal to 50 μm can be used as the base layer 16.

For example, a composite material such as a resin film to which a metal plate, a thin sheet-like glass plate, or a film of an inorganic material is attached with the use of a resin layer can be used as the base layer 16.

For example, a composite material formed by dispersing a fibrous or particulate metal, glass, or inorganic material into a resin or a resin film can be used as the base layer 16.

Specifically, a resin film or a resin plate of polyester, polyolefin, polyamide, polyimide, polycarbonate, an acrylic resin, or the like can be used.

Specifically, non-alkali glass, soda-lime glass, potash glass, crystal glass, or the like can be used.

Specifically, a metal oxide film, a metal nitride film, a metal oxynitride film, or the like can be used. For example, silicon oxide, silicon nitride, silicon oxynitride, an alumina film, or the like can be used.

Specifically, SUS, aluminum, or the like can be used.

### <Structure Example 2 of Sensor>

Another structure of the sensor of one embodiment of the present invention is described with reference to FIG. 2.

FIG. 2(A) is a schematic view and a circuit diagram illustrating a bottom of the sensor 10B of one embodiment of the present invention. Note that the broken lines and black dots regularly arranged in the figure indicate that repeated arrangement of a rectangle region is omitted.

FIG. 2(B) is a detailed bottom view of a rectangle region of a portion enclosed by the broken-line circle in FIG. 2(A).

FIG. 2(C) is a bottom view of a portion including the transistor M1 denoted by the symbol in FIG. 2(A).

FIG. 2(D) is a cross-sectional view illustrating structures of cross sections along the cutting plane line X1-X2 and the cutting plane line Y1-Y2 shown in FIG. 2(C).

The sensor 10B described in this embodiment includes the window portion 14 transmitting visible light, a coloring layer which overlaps with the window portion 14 and transmits light of a predetermined color, a light-blocking layer BM surrounding the window portion 14, the sensor element C overlapping with the window portion 14, the sensor circuit 19 which overlaps with the light-blocking layer BM and is electrically connected to the sensor element C, and the flexible base layer 16 which supports the sensor element C and the sensor circuit 19 (see FIG. 2(A) to FIG. 2(D)).

In addition, the sensor element C includes the flexible insulating layer 13, and the first electrode 11 and the second electrode 12 between which the insulating layer 13 is interposed.

The sensor circuit 19 supplies the sensor signal DATA on the basis of a change in the capacitance of the sensor element C.

Furthermore, the sensor circuit 19 may have a structure in which it includes the first transistor M1 comprising a gate electrically connected to the first electrode 11 of the sensor element C and a first electrode electrically connected to the wiring VPI through which, for example, the ground potential can be supplied (see FIG. 2(A)).

Furthermore, the structure may include a second transistor M2 comprising a gate electrically connected to the scan line G1 through which the selection signal can be supplied, a first electrode electrically connected to the second electrode of the first transistor M1, and a second electrode electrically connected to, for example, the signal line DL through which the sensor signal DATA can be supplied.

Furthermore, the structure may include a third transistor M3 comprising a gate electrically connected to the wiring RES through which the reset signal can be supplied, a first electrode electrically connected to the first electrode 11 of the sensor element C, and a second electrode electrically connected to, for example, the wiring VRES through which the ground potential can be supplied.

Furthermore, the wiring CS, which is electrically connected to the second electrode 12 of the sensor element C and through which the control signal capable of controlling the potential of the second electrode can be supplied, may be provided.

The sensor 10B described in this embodiment includes the window portion 14, the coloring layer which overlaps with the window portion 14 and transmits light of a predetermined color, the light-blocking layer BM surrounding the window portion 14, the light-transmitting sensor element C which includes the flexible insulating layer 13 and the pair of electrodes between which it is interposed and overlaps with the window portion 14, the sensor circuit 19 which overlaps with the light-blocking layer BM and supplies the sensor signal DATA on the basis of a change in the capacitance of the sensor element C, and the flexible base layer 16 supporting the sensor element C and the sensor circuit 19.

Note that the capacitance of the sensor element C is changed when an object gets close to the first electrode 11 or the second electrode 12 or when the distance between the first electrode 11 and the second electrode 12 is changed, for example. Thus, the sensor 10 can supply the sensor signal DATA based on the change in the capacitance of the sensor element C, can transmit visible light, and can be bent. Consequently, a novel sensor that is highly convenient or reliable can be provided.

Note that through the wiring VRES and the wiring VPI, for example, the ground potential can be supplied, and through the wiring VPO and the wiring BR, for example, a high power supply potential can be supplied.

In addition, through the wiring RES, the reset signal can be supplied, through the scan line G1, the selection signal can be supplied, and through the wiring CS, a control signal which controls the potential of the second electrode 12 of the sensor element can be supplied.

Furthermore, through the signal line DL, the sensor signal DATA can be supplied, and through a terminal OUT, a signal converted based on the sensor signal DATA can be supplied.

The sensor 10B described in this embodiment is different from the sensor 10 described with reference to FIG. 1 in including the coloring layer which overlaps with the window portion 14 and transmits light of a predetermined color, in including the light-blocking layer BM surrounding the window portion 14, in including the sensor circuit 19 placed at a position overlapping with the light-blocking layer BM, in including the second transistor as the first switch, and including the third transistor as the second switch. Different structures are described in detail here. Refer to the above-described description for the part where the same structures can be employed.

Individual components forming the sensor 10B are described below. Note that these components cannot be clearly distinguished and one component also serves as another component or includes part of another component in some cases.

### <<Window Portion, Coloring Layer, and Light-Blocking Layer>>

The window portion 14 transmits visible light.

The coloring layer transmitting light of a predetermined color is provided at a position overlapping with windows portion 14. For example, a coloring layer CFB transmitting blue light, a coloring layer CFG, or a coloring layer CFR is included (see FIG. 2(B) to FIG. 2(D)).

Note that, in addition to blue light, green light, and/or red light, coloring layers transmitting light of various colors, such as a coloring layer transmitting white light or a coloring layer transmitting yellow light, can be included.

For the coloring layers, metal materials, pigment, dyes, or the like can be used.

Note that a light-transmitting overcoat layer covering the coloring layer and the light-blocking layer BM can be included.

The light-blocking layer BM surrounding the window portion 14 is included. The light-blocking layer BM transmits light less easily than the window portion 14.

For the light-blocking layer BM, carbon black, a metal oxide, a composite oxide containing a solid solution of a plurality of metal oxides, or the like can be used.

### <<Sensor Circuit and Wiring>>

The sensor circuit 19 and the wiring are preferably included at positions overlapping with the light-blocking layer BM.

A transistor that can be formed in the same process as the first transistor M1 can be used as the second transistor M2 and the third transistor M3.

Furthermore, in the case where the wiring is placed so as to overlap with the light-blocking layer BM, a material that does not easily transmit visible light can be used as the wiring. For example, a material having more excellent conductivity than a conductive film having a light-transmitting property can be used. Specifically, a metal can be used.

The base layer 16 may be provided with the sensor circuit 19 by processing a film formed on the base layer 16.

Alternatively, the sensor circuit 19 may be formed on another base layer so that the sensor circuit 19 formed on another base layer is transferred to the base layer 16.

Note that a manufacturing method of the sensor including the sensor circuit 19 is described in detail in Embodiment 6.

### <Driving Method of Sensor>

The driving method of the sensor 10B described in this embodiment is described with reference to FIG. 3.

FIG. 3(A) is a circuit diagram illustrating a structure of the sensor 10B and a converter CONV of one embodiment of the present invention, and FIG. 3(B-1) and FIG. 3(B-2) are timing charts illustrating the driving method.

Note that various circuits that can convert the sensor signal DATA and supply it to the terminal OUT can be used as the converter CONV. For example, a source follower circuit, a current mirror circuit, or the like may be formed by the electrical connection between the converter CONV and the sensor circuit 19.

Specifically, by using the converter CONV using a transistor M4, the source follower circuit can be formed (see 3(A)). Note that a transistor that can be formed in the same process as the first transistor M1 to the third transistor M3 may be used as the transistor M4.

### <<First Step>>

In a first step, the reset signal that turns on the third transistor and then turns it off is supplied to the gate, so that the potential of the first electrode of the sensor element C is set to a predetermined potential (see a period T1 in FIG. 3(B-1)).

Specifically, the wiring RES is made to supply the reset signal. The third transistor to which the reset signal is supplied can set the potential of the node A to the ground potential, for example (see FIG. 3(A)).

### <<Second Step>>

In a second step, a selection signal that turns on the second transistor M2 is supplied to the gate, and the second electrode of the first transistor is electrically connected to the signal line DL.

Specifically, the scan line G1 is made to supply the selection signal. Through the second transistor M2 to which the selection signal is supplied, the second electrode of the first transistor is electrically connected to the signal line DL (see a period T2 in FIG. 3(B-1)).

### <<Third Step>>

In a third step, the control signal is supplied to the second electrode 12 of the sensor element, and the control signal and a potential that varies based on the capacitance of the sensor element C are supplied to the gate of the first transistor M1.

Specifically, the wiring CS is made to supply a rectangular control signal. The sensor element C whose second electrode 12 is supplied with the rectangular control signal increases the potential of the node A on the basis of the capacitance of the sensor element C (see the latter half in the period T2 in FIG. 3(B-1)).

For example, in the case where the sensor element is put in the air, when an object whose dielectric constant is higher than that of the air is placed in the proximity of the second electrode 12 of the sensor element C, the apparent capacitance of the sensor element C is increased.

Thus, a change in the potential of the node A due to the rectangular control signal is reduced as compared with the case where an object having a higher dielectric constant than the air is not placed in the proximity (see a solid line in FIG. 3(B-2)).

### <<Fourth Step>>

In a fourth step, a signal based on a change in the potential of the gate of the first transistor M1 is supplied to the signal line DL.

For example, a change in current due to the change in the potential of the gate of the first transistor M1 is supplied to the signal line DL.

The converter CONV converts a change in current flowing through the signal line DL into a voltage change and supplies it.

### <<Fifth Step>>

In a fifth step, the selection signal that turns off the second transistor is supplied to the gate.

This embodiment can be combined with another embodiment in this specification as appropriate.

### Embodiment 2

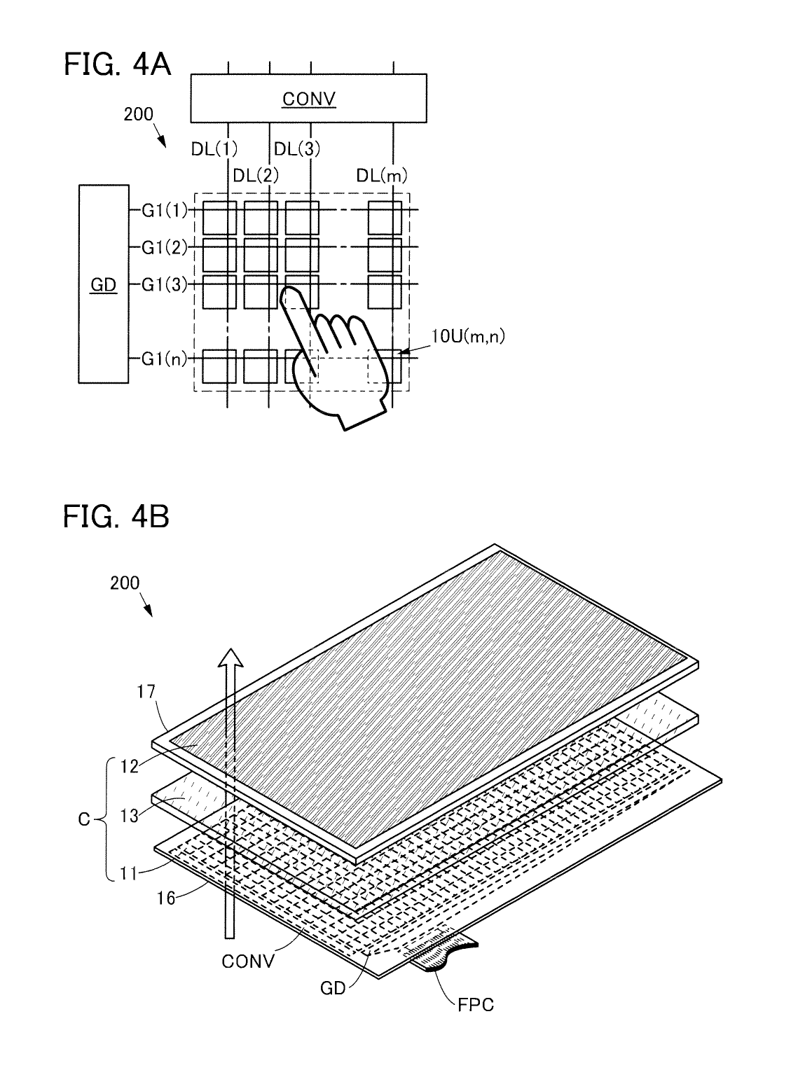

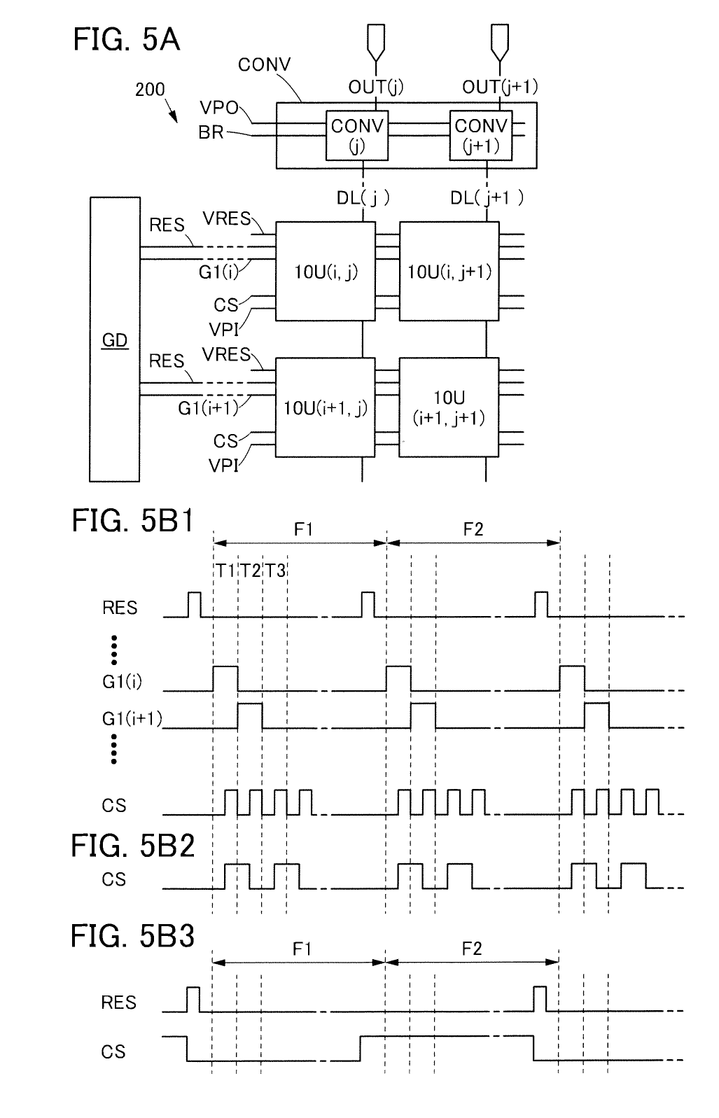

In this embodiment, a structure of an input device of one embodiment of the present invention is described with reference to FIG. 4 and FIG. 5.

FIG. 4 illustrates a structure of an input device 200 of one embodiment of the present invention.

FIG. 5 illustrates a driving method of the input device 200 of one embodiment of the present invention.

FIG. 4(A) is a block diagram illustrating the structure of the input device 200, and FIG. 4(B) is a projection view illustrating the appearance of the input device 200.

Note that the input device 200 can also be referred to as touch sensor.

### <Structure Example of Input Device>

The input device 200 described in this embodiment includes a plurality of sensor units 10U arranged in a matrix, the scan lines GI to which the plurality of sensor units 10U placed along the row direction are electrically connected, the signal lines DL to which the plurality of sensor units 10U placed along the column direction are electrically connected, and the flexible base layer 16 provided with the sensor units 10U, the scan lines G1, and the signal lines DL (see FIG. 4(A)).

For example, the plurality of sensor units 10U can be arranged in a matrix of n rows and m columns (n and m are natural numbers greater than or equal to 1).

Note that the sensor unit 10U provided in the i-th row and the j-th column (i is a natural number less than or equal to n, and j is a natural number less than or equal to m) is referred to as sensor unit 10U(i, j). Furthermore, the scan line G1 provided in the i-th row is referred to as scan line G1(i), and the signal line DL provided in the j-th column is referred to as signal line DL(J).

Then, the sensor unit 10U includes the window portion 14 (not illustrated) transmitting visible light, the sensor element C overlapping with the window portion 14, and the sensor circuit 19 (not illustrated) electrically connected to the sensor element C.

For example, a structure similar to that of the sensor 10B described in Embodiment 1 can be used as the sensor unit 10U (see FIG. 2).

The sensor element C includes the flexible insulating layer 13, and the first electrode 11 and the second electrode 12 between which the insulating layer 13 is interposed.

The sensor circuit 19 is supplied with the selection signal and supplies the sensor signal on the basis of a change in the capacitance of the sensor element C.

The selection signal can be supplied through the scan lines G1. The sensor signal can be supplied through the signal lines DL.

Furthermore, the input device 200 may have a structure in which the insulating layer 13 of the sensor element C contains a silicone gel and it can be folded at a radius of curvature of 4 mm or more, preferably 2 mm or more, more preferably 1 mm or more.

Furthermore, the sensor circuit 19 may have a structure in which it includes the first transistor M1 comprising a gate electrically connected to the first electrode 11 of the sensor element C and a first electrode electrically connected to the wiring VPI through which, for example, the ground potential can be supplied (see FIG. 3(A)).

Furthermore, the structure may include a second transistor M2 comprising a gate electrically connected to the scan line G1 through which the selection signal can be supplied, a first electrode electrically connected to the second electrode of the first transistor M1, and a second electrode electrically connected to, for example, the signal line DL through which the sensor signal DATA can be supplied.

Furthermore, the structure may include a third transistor M3 comprising a gate electrically connected to the wiring RES through which the reset signal can be supplied, a first electrode electrically connected to the first electrode of the sensor element C, and a second electrode electrically connected to, for example, the wiring VRES through which the ground potential can be supplied.

The input device 200 described in this embodiment includes sensor units which include the window portions which transmit visible light, the light-transmitting sensor elements which include the flexible insulating layer and a pair of electrodes between which it is interposed and overlap with the window portions, the sensor circuits which supply the sensor signal on the basis of a change in the capacitance of the sensor element and are arranged in a matrix, and the flexible base layer supporting the sensor units.

Note that the capacitance of the sensor element is changed when an object gets close to the first electrode or the second electrode 12 or when the distance between the first electrode and the second electrode 12 is changed, for example. Thus, the input device can supply the positional data of a sensor unit and the sensor signal detected by the sensor unit, can transmit visible light, and can be bent. Consequently, a novel input device that is highly convenient or reliable can be provided.

Furthermore, in the input device 200, the areas of the second electrodes 12 of the sensor elements C are 10 times or more, preferably 20 times or more as large as the sum of the areas of the first electrodes 11 included in the plurality of sensor elements C electrically connected to one signal line.

In the input device 200 described in this embodiment, one sensor unit 10U can be selected from the plurality of sensor units 10U connected to one signal line DL by using the selection signal, and the first electrode 11 having a sufficiently smaller area than the second electrode 12 is included.

Thus, the capacitance derived from the sensor unit that is selected can be separated from the capacitance derived from the sensor unit that is not selected. Furthermore, a sensor unit whose first electrode has a small area is placed, so that positional data can be acquired in detail. In addition, the first electrode does not easily get much noise. Consequently, a novel input device that is highly convenient or reliable can be provided.

The input device 200 may include a driver circuit GD which can supply selection signals at predetermined timings. For example, the driver circuit GD supplies selection signals to the scan lines in a predetermined order.

The input device 200 may include the converter CONV which converts the sensor signal DATA supplied from the sensor unit 10U. The converter CONV includes a plurality of converters CONV(1) to CONV(j) (I is a natural number greater than or equal to 1 and less than or equal to m). For example, the converter CONV(j) may convert the sensor signal DATA supplied through the signal line DL(j) and supply it.

The input device 200 may be electrically connected to a flexible printed substrate FPC. For example, the flexible printed substrate FPC may supply various potentials such as a power supply potential, various timing signals, or the like and may be supplied with a signal based on the sensor signal DATA.

Note that the input device described in this embodiment is different from the sensor 10 described with reference to FIG. 2 in Embodiment 1 in including the plurality of sensor units 10U having the same structure as the sensor 10B described in Embodiment 1 which are provided in a matrix over the base layer 16, including the plurality of scan lines G1 to which the plurality of sensor units 10U placed along the row direction are electrically connected, and including the signal lines DL to which the plurality of sensor units 10U placed along the column direction are electrically connected, and in that the first electrode 11 of the sensor unit 10U is sufficiently smaller than the second electrode 12. Different structures are described in detail here. Refer to the above-described description for the part where the same structures can be employed.

Individual components forming the input device 200 are described below.

Note that these components cannot be clearly distinguished and one component also serves as another component or includes part of another component in some cases.

### <<Overall Structure>>

The input device 200 includes the plurality of sensor units 10U, the scan lines G1, and the signal lines DL.

Further, the driver circuit GD and the converter CONV may be included.

The sensor circuits 19 of the plurality of sensor units 10U, the driver circuit GD, and the converter CONV can be configured using transistors formed in the same process.

<<Scan Lines and Signal Lines>>

The scan lines G1 and the signal lines DL are preferably placed at positions overlapping with the light-blocking film BM of the sensor unit 10U.

Note that the base layer 16 may be provided with the plurality of sensor units 10U arranged in a stripe pattern, a mosaic pattern, a delta pattern, a honeycomb pattern, or a Bayer pattern.

<<Driver Circuit GD>>

The driver circuit GD can be configured with a logic circuit using a variety of combinational circuits. For example, a shift register can be used.

<<Converter CONV>>

The convertor CONV includes a converter circuit. Various circuits that can convert the sensor signal DATA and supply it can be used. For example, a source follower circuit, a current mirror circuit, or the like may be formed by the electrical connection between the converter CONV and the sensor circuit 19.

### <Driving Method 1 of Input Device>

The driving method of the input device 200 described in this embodiment is described with reference to FIG. 5.

FIG. 5(A) is a block diagram illustrating the structure of the input device 200, and FIG. 5(B) is a timing chart illustrating the driving method of the input device 200.

Note that through the wiring VRES and the wiring VPI, for example, the ground potential can be supplied, and through the wiring VPO and the wiring BR, for example, a high power supply potential can be supplied.

In addition, through the wiring RES, the reset signal can be supplied. Through the scan line G1, the selection signal can be supplied. Through the wiring CS, the control signal can be supplied.

Furthermore, through the signal line DL, the sensor signal DATA can be supplied, and through a terminal OUT(j), a signal converted based on the sensor signal DATA can be supplied.

The driving method of the input device 200 described in this embodiment is different from the driving method of the sensor 10 described with reference to FIG. 3 in that one scan line G1(j) supplies the selection signal to the plurality of sensor units 10U at the same timing and in that the plurality of terminals OUT(j) supply signals converted based on the sensor signal DATA at the same timing. Such different steps are described in detail here. Refer to the above-described description for the part where the same steps can be employed.

### <<First Step>>

In a first step, the reset signal is supplied, and the potentials of the first electrodes 11 of the sensor elements C of all the sensor units 10U are set to predetermined potentials (see FIG. 3(A) and a period T1 in FIG. 5(B-1)). For example, the potentials of the first electrodes 11 of the sensor elements C are set to the ground potential.

Furthermore, for example, the value of i is set to 1 such that predetermined scan lines are selected in order. Note that the time when the value of i is 1 can be referred to as commencement time of an input frame period.

### <<Second Step>>

In a second step, a scan line G1(i) is selected, and the selection signal is supplied to sensor units 10U(i, 1) to 10U(i, m) electrically connected to the selected scan line G 1(i) during a predetermined period. The second electrode of the first transistor supplied with the selection signal is electrically connected to the signal lines DL(1) to DL(m) (see FIG. 3(A) and a period T2 in FIG. 5(B-1)).

### <<Third Step>>

In a third step, the predetermined control signal is supplied to the second electrode 12 of the sensor element, and the control signal and a potential that varies based on the capacitance of the sensor element C are supplied to the gate of the first transistor M1.

Note that a signal synchronizing with the selection signal can be used as the control signal.

Specifically, a square wave having the same cycle as the selection signal can be used (see FIG. 5(B-1)).

Specifically, a square wave having a cycle twice as long as the selection signal can be used (see FIG. 5(B-2)).

The sensor element C whose second electrode 12 is supplied with the rectangular control signal increases the potential of the node A on the basis of the capacitance of the sensor element C (see the latter half in the period T2 in FIG. 5(B-1)).

### <<Fourth Step>>

In a fourth step, a current that varies based on a change in the potential of the gate of the first transistor M1 is supplied to the signal line DL.

The converter CONV converts a change in current flowing through the signal line DL into a voltage change and supplies it.

### <<Fifth Step>>

In a fifth step, the selection signal that turns off the second transistor is supplied to the gate.

### <<Sixth Step>>

In a sixth step, 1 is added to the value of i, and the case where the value is n or less leads to the second step.

Specifically, in the case where the value of i is less than n, in the second step, a scan line G1(i+1) is selected, and the selection signal is supplied to sensor units 10U(i+1, 1) to 10U(i+1, m) electrically connected to the selected scan line G1(i+1) during a predetermined period. The second electrode of the first transistor supplied with the selection signal is electrically connected to the signal lines DL(1) to DL(m) (see FIG. 3(A) and a period T3 in FIG. 5(B-1)).

The case where the value obtained by adding 1 to the value of i is more than n leads to the first step. Furthermore, the time when the value obtained by adding 1 to the value of i is more than n can be referred to as termination time of the input frame period.

According to this driving method, all the sensor units supply the sensor signal DATA every input frame period.

For example, the sensor signal DATA contains positional data of an object in the proximity of each sensor unit. In addition, positional data of the sensor units placed in a matrix in advance is known.

By associating the sensor signal DATA with the positional data of the sensor units, the input device 200 can supply the positional data of the object in the proximity of the input device 200 every input frame period.

Specifically, the sensor signal DATA and the positional data of the sensor unit are analyzed using an arithmetic device, so that the positional data of the object in the proximity of the input device 200 can be known every input period.

### <Driving Method 2 of Input Device>

The driving method of the input device 200 described in this embodiment is described with reference to FIG. 5(B-3).

Note that the driving method of the input device described in this embodiment is different from the above-described driving method in the following points. In a first step, a control signal that sets the potential of the second electrode 12 of the sensor element C to a first potential is supplied. In a second step, when the value of i is greater than or equal to n and less than 2n, a scan line G1((i−n+1) is selected and the selection signal is supplied to the sensor units 10U(i−n+1, 1) to 10U(i−n+1, m). In a third step, a potential which varies based on a change in the capacitance of the sensor element C having the second electrode 12 supplied with the first potential or a second potential is supplied to the gate of the first transistor M1. In a sixth step, in the case where 1 is added to the value of i and the value is n+1, a control signal that sets the potential of the second electrode 12 of the sensor element to the second potential which is different from the first potential supplied in the first step is supplied. Such different structures are described in detail here. Refer to the above-described description for the part where the same structures can be employed.

### <<First Step>>

In the first step, the reset signal is supplied, and the potentials of the first electrodes of the sensor elements C of all the sensor units 10U are set to a predetermined potential (see FIG. 3(A) and a period U1 in FIG. 5(B-3)).

Furthermore, the control signal that sets the potential of the second electrode 12 of the sensor element C to the first potential is supplied.

Furthermore, for example, the value of i is set to 1 such that predetermined scan lines are selected in order. Note that the time when the value of i is 1 can be referred to as commencement time of an input frame period.

### <<Second Step>>

In the second step, when the value of i is less than n, the scan line G1(i) is selected, and the selection signal is supplied to the sensor units 10U(i, 1) to 10U(i, m) electrically connected to the selected scan line G1(i) during a predetermined period. The second electrode of the first transistor supplied with the selection signal is electrically connected to the signal lines DL(1) to DL(m).

In the second step, when the value of i is greater than or equal to n and less than 2n, a scan line G1(i−n+1) is selected, and the selection signal is supplied to the sensor units 10U(i−n+1, 1) to 10U(i−n+1, m) electrically connected to the selected scan line G1(i−n+1) during a predetermined period. The second electrode of the first transistor supplied with the selection signal is electrically connected to the signal line DL(1) to DL(m).

### <<Third Step>>

In the third step, a potential which varies based on a change in the capacitance of the sensor element C is supplied to the gate of the first transistor M1.

Specifically, the first potential or the second potential is supplied to the second electrode 12 of the sensor element C, and the sensor element C changes the potential of the node A on the basis of a change in the capacitance thereof (see FIG. 3(A)).

For example, in the case where the sensor element is put in the air, when an object whose dielectric constant is higher than that of the air is placed in the proximity of the second electrode 12 of the sensor element C, the apparent capacitance of the sensor element C is increased.

Thus, a change in the potential of the node A is reduced as compared with the case where an object having a higher dielectric constant than the air is not placed in the proximity.

### <<Sixth Step>>

In the sixth step, when 1 is added to the value of i and the value is n+1, the control signal that sets the potential of the second electrode 12 of the sensor element to the second potential which is different from the first potential supplied in the first step is supplied (see a period U2 in FIG. 5(B-3)).

Furthermore, the case where the value obtained by adding 1 to the value of i is 2n or less leads to the second step.

The case where the value obtained by adding 1 to the value of i is more than 2n leads to the first step. Note that the time when the value obtained by adding 1 to the value of i is more than 2n can be referred to as termination time of the input frame period.

According to this driving method, all the sensor units supply a set of sensor signals DATA every input frame period.

Specifically, a sensor signal DATA in the case where the potential of the second electrode 12 is the first potential and a sensor signal DATA in the case where it is the second potential are supplied.

For example, a difference between the set of sensor signals DATA contains positional data of an object in the proximity of each sensor unit. In addition, positional data of the sensor units placed in a matrix in advance is known.

By associating the difference between the set of sensor signals DATA with the positional data of the sensor units, the input device 200 can supply the positional data of the object in the proximity of the input device 200 every input frame period.

Specifically, the difference between the set of sensor signals DATA and the positional data of the sensor unit are analyzed using an arithmetic device, so that the positional data of the object in the proximity of the input device 200 can be known every input period.

This embodiment can be combined with another embodiment in this specification as appropriate.

### Embodiment 3

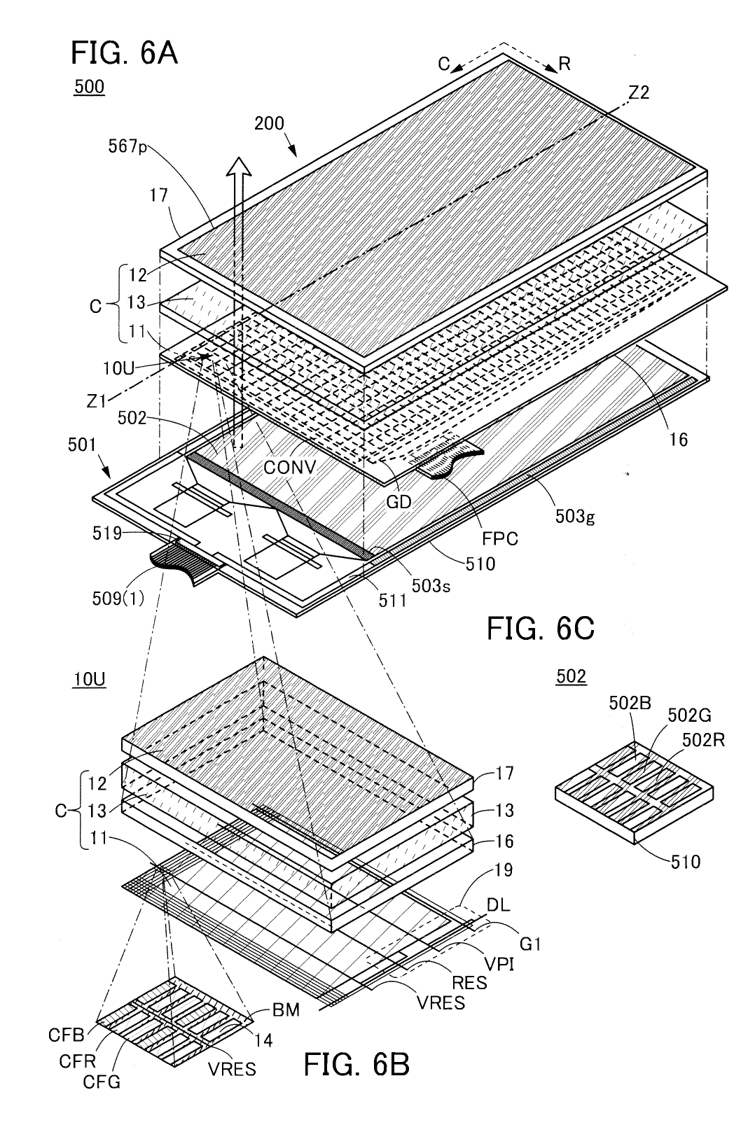

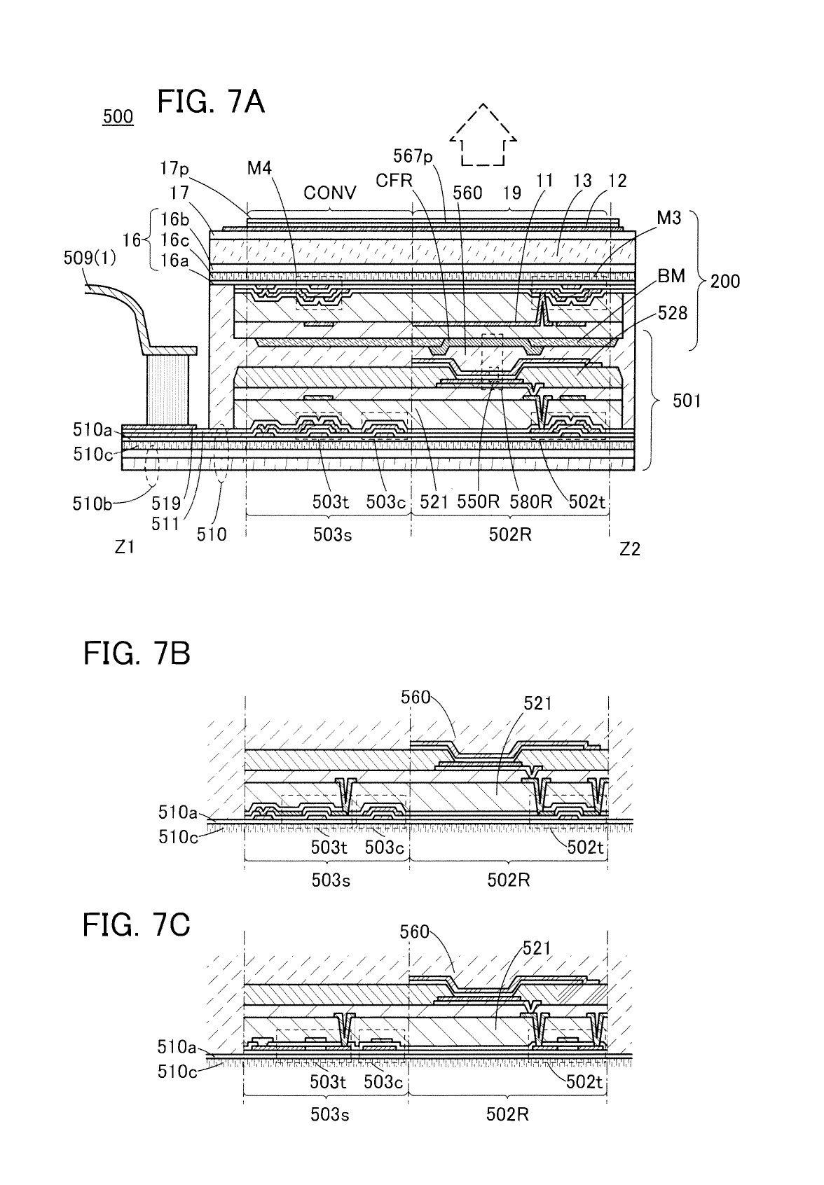

In this embodiment, a structure of the input/output device of one embodiment of the present invention is described with reference to FIG. 6 and FIG. 7.

FIG. 6 illustrates projection views of the structure of the input/output device of one embodiment of the present invention.

FIG. 6(A) is a projection view of an input/output device 500 of one embodiment of the present invention, and FIG. 6(B) is a projection view of the structure of a sensor unit 10U included in the input/output device 500.

FIG. 7 illustrates cross-sectional views of structures of the input/output device 500 of one embodiment of the present invention.

FIG. 7(A) is a cross-sectional view along Z1-Z2 of the input/output device 500 of one embodiment of the present invention which is illustrated in FIG. 6.

Note that the input/output device 500 can also be referred to as touch panel.

### <Structure Example of Input/Output Device>

The input/output device 500 described in this embodiment includes the flexible input device 200 including the plurality of sensor units 10U which include the window portions 14 transmitting visible light and are arranged in a matrix, the scan lines G1 to which the plurality of sensor units 10U placed along the row direction (indicated by the arrow R in the figure) are electrically connected, the signal lines DL to which the plurality of sensor units 10U placed along the column direction (indicated by the arrow C in the figure) are electrically connected, the first flexible base layer 16 supporting the sensor units 10U, the scan lines G1, and the signal lines DL, and the display portion 501 including a plurality of pixels 502 which are arranged in a matrix and overlap with the window portions 14 and a second flexible base layer 510 supporting the pixels 502 (see FIG. 6(A) to FIG. 6(C)).

The sensor unit 10U includes the sensor element C overlapping with the window portion 14 and the sensor circuit 19 electrically connected to the sensor element C (see FIG. 6(B)).

The sensor element C includes the flexible insulating layer 13, and the first electrode 11 and the second electrode 12 between which the insulating layer 13 is interposed.

The sensor circuit 19 is supplied with the selection signal, and supplies the sensor signal DATA on the basis of a change in the capacitance of the sensor element C.

The sensor circuit 19 is supplied with the selection signal, and supplies the sensor signal DATA on the basis of a change in the capacitance of the sensor element C.

The selection signal can be supplied through the scan lines G1. The sensor signal DATA can be supplied through the signal lines DL. The sensor circuit 19 is placed so as to overlap with gaps between the window portions 14.

The input/output device 500 described in this embodiment further includes a coloring layer between the sensor unit 10U and the pixel 502 overlapping with the window portion 14 of the sensor unit 10U.

The input/output device 500 described in this embodiment includes the flexible input device 200 including the plurality of sensor units 10U provided with the window portions 14 which transmit visible light, the flexible display portion 501 including the plurality of pixels 502 overlapping with the window portions 14, and the coloring layer between the window portion 14 and the pixel 502.

Thus, the input/output device can supply the sensor signal based on a change in capacitance and the positional data of the sensor unit that supplies the sensor signal, can display image data associated with the positional data of the sensor unit, and can be bent. As a result, a novel input/output device that is highly convenient or reliable can be provided.

The input/output device 500 may include the flexible printed substrate FPC1 supplied with a signal from the input device 200 and/or the flexible printed substrate FPC2 supplying a signal including image data to the display portion 501.

In addition, the protective layer 17p preventing the input/output device 500 from being scratched and/or an anti-reflective layer 567p which reduces the intensity of external light reflected by the input/output device 500 may be provided.

Moreover, the input/output device 500 includes a signal line driver circuit 503s which supplies an image line signal to the scan line of the display portion 501, a wiring 511 supplying a signal, and a terminal 519 electrically connected to the flexible printed substrate FPC2.

Individual components forming the input/output device 500 are described below. Note that these units cannot be clearly distinguished and one unit also serves as another unit or include part of another unit in some cases.

For example, the input device 200 provided with the coloring layers overlapping with the plurality of the window portions 14 serves not only as the input device 200 but also as color filters.

Furthermore, for example, the input/output device 500 in which the input device 200 overlaps with the display portion 501 serves not only as the input device 200 but also as the display portion 501.

### <<Overall Structure>>

The input/output device 500 includes the input device 200 and the display portion 501 (see FIG. 6(A)).

### <<Input Device 200>>

The input device 200 includes the plurality of sensor units 10U and the flexible base layer 16 supporting the sensor units.

For example, the plurality of sensor units 10U are arranged in a matrix of 40 rows and 15 columns over the flexible base layer 16. In addition, the size of the sensor unit may be 7.668 mm wide and 5.112 mm long.

### <<Window Portion 14, Coloring Layer, and Light-Blocking Layer BM>>

The window portion 14 transmits visible light.

The coloring layer transmitting light of a predetermined color is provided to overlap with the window portion 14. For example, the coloring layer CFB transmitting blue light, the coloring layer CFG, or the coloring layer CFR is provided (see FIG. 6B).

Note that, in addition to the coloring layers transmitting blue light, green light, and/or red light, coloring layers transmitting light of various colors such as a coloring layer transmitting white light and a coloring layer transmitting yellow light can be provided.

For the coloring layer, a metal material, a pigment, dye, or the like can be used.

The light-blocking layer BM is provided so as to surround the window portions 14. The light-blocking layer BM does not easily transmit light as compared to the window portion 14.

For the light-blocking layer BM, carbon black, a metal oxide, a composite oxide containing a solid solution of a plurality of metal oxides, or the like can be used.

The scan line G1, the signal line DL, the wiring VPI, the wiring RES, the wiring VRES, and the sensor circuit 19 are provided to overlap with the light-blocking layer BM.

Note that a light-transmitting overcoat layer covering the coloring layer and the light-blocking layer BM can be provided.

### <<Sensor Element C>>

The sensor element C includes the first electrode 11, the second electrode 12, and the insulating layer 13 having flexibility between the first electrode 11 and the second electrode 12 (see FIG. 7(A)).

The first electrode 11 is formed apart from other regions, for example, is formed into an island shape. In particular, a layer that can be formed in the same process as the first electrode 11 is preferably placed in the proximity of the first electrode 11 so that a user of the input/output device 500 does not recognize the first electrode 11. Further preferably, the number of the window portions 14 placed in a distance between the first electrode 11 and the layer placed in the proximity of the first electrode 11 is as small as possible. In particular, the window portion 14 is preferably not placed in the gap. Note that the size of the first electrode 11 can be substantially equal to the size of the sensor unit.

The second electrode 12 is provided to overlap with the first electrode 11, and the insulating layer 13 is provided between the first electrode 11 and the second electrode 12.

Note that the area of the first electrode can be smaller than the area of the second electrode. For example, the areas of the second electrodes are set to 0.8 times or more as large as the total area of the first electrodes included in the plurality of sensor units which are electrically connected to one signal line DL and aligned in the column direction.

For example, when an object in the air whose dielectric constant is different from that of the air gets close to the first electrode 11 or the second electrode 12 of the sensor element C placed in the air, the capacitance of the sensor element C is changed. Specifically, when a finger or the like gets close to the sensor element C, the capacitance of the sensor element C is changed. Thus, the use as a proximity sensor is possible.

For example, a capacitor that can change its shape and the capacitance of which varies with the change in shape can be used as the sensor element C.

Specifically, a capacitor C, in which the distance between the first electrode 11 and the second electrode 12 becomes small when an object such as a finger touches the sensor element C, can be used. When the distance between the first electrode 11 and the second electrode 12 becomes small, the capacitance of the sensor element C is increased. Thus, the use as a contact sensor is possible.

Specifically, when the sensor element C is bent, the distance between the first electrode 11 and the second electrode 12 becomes small. Accordingly, the capacitance of the sensor element C is increased. Thus, the use as a bend sensor is possible.

A conductive material can be used for the first electrode 11 and the second electrode 12.

For example, an inorganic conductive material, an organic conductive material, metal, conductive ceramic, or the like can be used for the first electrode 11 and the second electrode 12.

Specifically, a metal element selected from aluminum, chromium, copper, tantalum, titanium, molybdenum, tungsten, nickel, silver, and manganese, an alloy including the above-described metal element, an alloy including any of the above-described metal elements in combination, or the like can be used.

Alternatively, a conductive oxide such as indium oxide, indium tin oxide, indium zinc oxide, zinc oxide, or zinc oxide to which gallium is added can be used.

Alternatively, graphene or graphite can be used. A film containing graphene can be formed, for example, by reducing graphene oxide in a film containing graphene oxide. As a reducing method, a method with application of heat, a method using a reducing agent, and the like can be given.

Alternatively, a conductive high molecule can be used.

### <<Sensor Circuit 19>>

The sensor circuit 19 includes, for example, the transistors M1 to M3. The sensor circuit 19 also includes wirings through which a power supply potential and a signal are supplied. For example, the wiring VPI, the wiring CS, the scan line G1, the wiring RES, the wiring VRES, the signal line DL, and the like are included.

Note that a specific structure of the sensor circuit 19 is described in detail in Embodiment 2.

Note that the sensor circuit 19 may be placed in a region not overlapping with the window portion 14. For example, the wirings are placed in a region not overlapping with the window portion 14, so that an object on one side of the sensor 10 can be easily viewed from the other side.

For example, transistors that can be formed in the same process can be used as the transistors M1 to M3.

The transistor M1 includes a semiconductor layer. For example, a group 4 element, a compound semiconductor, or an oxide semiconductor can be used for the semiconductor layer. Specifically, a semiconductor containing silicon, a semiconductor containing gallium arsenide, an oxide semiconductor containing indium, or the like can be used. In addition, the semiconductor may be a single crystal, a polycrystal, amorphous, or a mixture including any of these.

Note that a structure of a transistor in which an oxide semiconductor is used for the semiconductor layer is described in detail in Embodiment 5.

For the wiring, a conductive material can be used.

For example, an inorganic conductive material, an organic conductive material, metal, conductive ceramic, or the like can be used for the wiring. Specifically, a material which is the same as those of the first electrode 11 and the second electrode 12 can be used.

For the scan line G1, the signal line DL, the wiring VPI, the wiring RES, and the wiring VRES, a metal material such as aluminum, gold, platinum, silver, nickel, titanium, tungsten, chromium, molybdenum, iron, cobalt, copper, or palladium, or an alloy material containing the metal material can be used.

The base layer 16 may be provided with the sensor circuit 19 by processing a film formed on the base layer 16.

Alternatively, the sensor circuit 19 formed on another base layer may be transferred to the base layer 16.

### <<Base Layer 16>>

For the flexible base layer 16, an organic material, an inorganic material, or a composite material of an organic material and an inorganic material can be used.

For the base layer 16, a material with a thickness greater than or equal to 5 μm and less than or equal to 2500 μm, preferably greater than or equal to 5 μm and less than or equal to 680 μm, further preferably greater than or equal to 5 μm and less than or equal to 170 μm, further preferably greater than or equal to 5 μm and less than or equal to 45 μm, further preferably greater than or equal to 8 μm and less than or equal to 25 μm can be used.

A material with which passage of impurities is inhibited can be preferably used for the base layer 16. For example, a material with a vapor permeability less than or equal to 10⁻⁵ g/m²·day, preferably less than or equal to 10⁻⁶ g/m²·day can be favorably used.

Preferably, materials having substantially equal coefficients of linear expansion can be used for the base layer 16. For example, the coefficients of linear expansion of the materials are preferably less than or equal to 1×10⁻³/K, further preferably less than or equal to 5×10⁻⁵/K, and still further preferably less than or equal to 1×10⁻⁵/K.

For example, an organic material such as a resin, a resin film, or a plastic film can be used as the base layer 16.

For example, an inorganic material such as a metal plate or a thin glass plate with a thickness greater than or equal to 10 μm and less than or equal to 50 μm can be used as the base layer 16.

For example, a composite material such as a resin film to which a metal plate, a thin glass plate, or a film of an inorganic material is attached with the use of a resin layer can be used as the base layer 16.

For example, a composite material formed by dispersing a fibrous or particulate metal, glass, or inorganic material into a resin or a resin film can be used as the base layer 16.

For example, as the resin layer, thermosetting resin or an ultraviolet curable resin can be used.

Specifically, a resin film or a resin plate of polyester, polyolefin, polyamide, polyimide, polycarbonate, an acrylic resin, or the like can be used.

Specifically, non-alkali glass, soda-lime glass, potash glass, crystal glass, or the like can be used.

Specifically, a metal oxide film, a metal nitride film, a metal oxynitride film, or the like can be used. For example, silicon oxide, silicon nitride, silicon oxynitride, an alumina film, or the like can be used.

Specifically, SUS, aluminum, or the like in which an opening portion is provided can be used.

Specifically, an acrylic resin, a urethane resin, an epoxy resin, or a resin having a siloxane bond can be used.

For example, a stack in which a base layer 16b having flexibility, a barrier film 16a which prevents diffusion of impurities, and a resin layer 16c attaching the barrier film 16a to the base layer 16b are stacked can be preferably used for the base layer 16 (see FIG. 7(A)).

Specifically, a film containing a stacked-layer material of a 600-nm-thick silicon oxynitride film and a 200-nm-thick silicon nitride film can be used as the barrier film 16a.

Specifically, a film including a stacked-layer material of a 600-nm-thick silicon oxynitride film, a 200-nm-thick silicon nitride film, a 200-nm-thick silicon oxynitride film, a 140-nm-thick silicon nitride oxide film, and a 100-nm-thick silicon oxynitride film stacked in this order can be used as the barrier film 16a.

A resin film or a resin plate of polyester, polyolefin, polyamide, polyimide, polycarbonate, an acrylic resin, or the like can be used as the base layer 16b.

For example, materials that include polyester, polyolefin, polyamide (e.g., nylon or aramid), polyimide, polycarbonate, or a resin having an acrylic bond, a urethane bond, an epoxy bond, or a siloxane bond can be used for the resin layer 16c.

<<Base Layer 17 and Protective Layer 17p>>

The flexible base layer 17 and/or the protective layer 17p can be provided. The flexible base layer 17 or the protective layer 17p can prevent the input device 200 from being scratched.

For example, a resin film, resin plate, a stack, or the like of polyester, polyolefin, polyamide, polyimide, polycarbonate, an acrylic resin, or the like can be used as the base layer 17.

For example, a hard coat layer or a ceramic coat layer can be used as the protective layer 17p. Specifically, a layer containing a UV curable resin or aluminum oxide may be formed at a position overlapping with the second electrode 12.

### <<Display Portion 501>>

The display portion 501 includes the plurality of pixels 502 arranged in a matrix (see FIG. 6(C)).

For example, the pixel 502 includes a sub-pixel 502B, a sub-pixel 502G, and a sub-pixel 502R, and each sub-pixel includes a display element and a pixel circuit that drives the display element.

In the pixel 502, the sub-pixel 502B is placed at a position overlapping with the coloring layer CFB, the sub-pixel 502G is placed at a position overlapping with the coloring layer CFG, and the sub-pixel 502R is placed at a position overlapping with the coloring layer CFR.

In this embodiment, an example of using an organic electroluminescent element that emits white light as the display element is described; however, the display element is not limited to an element.

For example, organic electroluminescent elements that emit light of different colors may be applied to sub-pixels so that the light of different colors can be emitted from the respective sub-pixels.

Other than organic electroluminescent elements, any of various display elements such as display elements (electronic ink) that perform display by an electrophoretic method, an electronic liquid powder (registered trademark) method, an electrowetting method, or the like; MEMS shutter display elements; optical interference type MEMS display elements; and liquid crystal elements can be used.

Furthermore, use in a transmissive liquid crystal display, a transflective liquid crystal display, a reflective liquid crystal display, a direct-view liquid crystal display, or the like is possible. In the case of achieving a transflective liquid crystal display or a reflective liquid crystal display, some or all of pixel electrodes function as reflective electrodes. For example, some or all of pixel electrodes are formed to contain aluminum, silver, or the like. Furthermore, in such a case, a storage circuit such as an SRAM can be provided under the reflective electrodes, so that power consumption can further be reduced. Furthermore, a structure suitable for employed display elements can be selected from among a variety of structures of pixel circuits.

In the display portion, an active matrix method in which an active element is included in a pixel or a passive matrix method in which an active element is not included in a pixel can be used.

In an active matrix method, as an active element (an active element or a non-linear element), not only a transistor but also various active elements (active elements or non-linear elements) can be used. For example, an MIM (Metal Insulator Metal), a TFD (Thin Film Diode), or the like can also be used. Since such an element has a small number of manufacturing steps, manufacturing cost can be reduced or yield can be improved. Alternatively, since the size of the element is small, the aperture ratio can be improved, so that power consumption can be reduced or higher luminance can be achieved.

As a method other than the active matrix method, the passive matrix method in which an active element (an active element or a non-linear element) is not used can also be used. Since an active element (an active element or a non-linear element) is not used, the number of manufacturing steps is small, so that manufacturing cost can be reduced or yield can be improved. Alternatively, since an active element (an active element or a non-linear element) is not used, the aperture ratio can be improved, so that power consumption can be reduced or higher luminance can be achieved, for example.

### <<Base Layer 510>>

For the base layer 510, a material having flexibility can be used. For example, the material that can be used for the base layer 16 can be used for the base layer 510.

For example, a stack in which a base layer 510b having flexibility, a barrier film 510a that prevents diffusion of impurities, and a resin layer 510c attaching the barrier film 510a to the base layer 510b are stacked can be preferably used for the base layer 510 (see FIG. 7(A)).

### <<Sealant 560>>

The sealant 560 attaches the base layer 16 to the base layer 510. The sealant 560 has a higher refractive index than air. In the case of extracting light to the sealant 560 side, the sealant 560 also serves as a layer having an optical adhesive function.

The pixel circuits and light-emitting elements (e.g., a light-emitting element 550R) are provided between the base layer 510 and the base layer 16.

### <<Structure of Pixels>>

The sub-pixel 502R includes the light-emitting module 580R.

The sub-pixel 502R includes the light-emitting element 550R and the pixel circuit that can supply electric power to the light-emitting element 550R and includes a transistor 502t. Furthermore, the light-emitting module 580R includes the light-emitting element 550R and an optical element (e.g., a coloring layer CFR).

The light-emitting element 550R includes a lower electrode, an upper electrode, and a layer containing a light-emitting organic compound between the lower electrode and the upper electrode.

The light-emitting module 580R includes the coloring layer CFR on the light extraction side. The coloring layer transmits light having a particular wavelength, and, for example, a layer that selectively transmits light of red, green, or blue color can be used. Note that other sub-pixels may be provided so as to overlap with the window portions, which are not provided with the coloring layers, so that light from the light-emitting element can be emitted without passing through the coloring layers.

In the case where the sealant 560 is provided on the light extraction side, the sealant 560 is in contact with the light-emitting element 550R and the coloring layer CFR.

The coloring layer CFR is placed at a position overlapping with the light-emitting element 550R. Accordingly, part of light emitted from the light-emitting element 550R passes through the coloring layer CFR and is emitted to the outside of the light-emitting module 580R as indicated by an arrow in the figure.

The light-blocking layer BM is located so as to surround the coloring layer (e.g., the coloring layer CFR).

### <<Structure of Pixel Circuit>>

An insulating film 521 covering the transistor 502t included in the pixel circuit is provided. The insulating film 521 can be used as a layer for planarizing unevenness due to the pixel circuit. A stacked-layer film including a layer that can prevent diffusion of impurities can be used as the insulating film 521. This can prevent the reliability of the transistor 502t or the like from being lowered by diffusion of impurities.

The lower electrode is placed over the insulating film 521, and a partition wall 528 is provided over the insulating film 521 so as to overlap with an end portion of the lower electrode.

The lower electrode is included in the light-emitting element (e.g., the light-emitting element 550R); the layer containing a light-emitting organic compound is provided between the upper electrode and the lower electrode. The pixel circuit supplies power to the light-emitting element.

Furthermore, a spacer that adjusts the distance between the base layer 16 and the base layer 510 is provided over the partition wall 528.

### <<Structure of Signal Line Driver Circuit>>

The signal line driver circuit 503s includes a transistor 503t and a capacitor 503c. Note that a transistor formed over the same substrate in the same process as in the pixel circuit can be used in the driver circuit.

### <<Converter CONV>>

Any of various circuits that can convert the sensor signal DATA supplied from the sensor unit 10U and supply it to the flexible printed substrate FPC1 can be used for a converter CONV (see FIG. 6(A) and FIG. 7(A)).

For example, the transistor M4 can be used in the converter CONV.

### <<Other Structures>>

The display portion 501 includes an anti-reflective layer 567p at a position overlapping with pixels. As the anti-reflective layer 567p, a circular polarizing plate can be used, for example.

The display portion 501 includes the wirings 511 through which signals are supplied. The wirings 511 are provided with the terminal 519. Note that the flexible printed substrate FPC2 through which signals such as an image signal and a synchronization signal can be supplied is electrically connected to the terminal 519.

Note that a printed wiring board (PWB) may be attached to the flexible printed substrate FPC2.

The display portion 501 includes wirings such as scan lines, signal lines, and power supply lines. Any of various conductive films can be used for the wirings.

Specifically, a metal element selected from aluminum, chromium, copper, tantalum, titanium, molybdenum, tungsten, nickel, yttrium, zirconium, silver, and manganese; an alloy containing any of the above-described metal elements; an alloy containing any of the above-described metal elements in combination; or the like can be used. In particular, one or more elements selected from aluminum, chromium, copper, tantalum, titanium, molybdenum, and tungsten are preferably contained. In particular, an alloy of copper and manganese is suitably used in microfabrication with the use of a wet etching method.

Specifically, a two-layer structure in which a titanium film is stacked over an aluminum film, a two-layer structure in which a titanium film is stacked over a titanium nitride film, a two-layer structure in which a tungsten film is stacked over a titanium nitride film, a two-layer structure in which a tungsten film is stacked over a tantalum nitride film or a tungsten nitride film, a three-layer structure including a titanium film, an aluminum film stacked over the titanium film, and a titanium film further formed thereover, or the like can be used.

Specifically, a stacked-layer film in which a film of an element selected from titanium, tantalum, tungsten, molybdenum, chromium, neodymium, and scandium is stacked over an aluminum film, a stacked-layer film in which an alloy film in which a plurality of elements selected from titanium, tantalum, tungsten, molybdenum, chromium, neodymium, and scandium are combined is stacked over an aluminum film, or a stacked-layer film in which a nitride film containing an element selected from titanium, tantalum, tungsten, molybdenum, chromium, neodymium, and scandium is stacked can be used.

Alternatively, a light-transmitting conductive material containing indium oxide, tin oxide, or zinc oxide may be used.

### <Modification Example of Display Portion>

Various transistors can be used in the display portion 501.

A structure of the case of using bottom-gate transistors in the display portion 501 is illustrated in FIG. 7(A) and FIG. 7(B).

For example, a semiconductor layer containing an oxide semiconductor, amorphous silicon, or the like can be used in the transistor 502t and the transistor 503t illustrated in FIG. 7(A).

For example, a film represented by an In-M-Zn oxide which contains at least indium (In), zinc (Zn), and M (a metal such as Al, Ga, Ge, Y, Zr, Sn, La, Ce, or Hf) is preferably included. Alternatively, both In and Zn are preferably contained.

As a stabilizer, gallium (Ga), tin (Sn), hafnium (Hf), aluminum (Al), zirconium (Zr), and the like can be given. As another stabilizer, lanthanoid such as lanthanum (La), cerium (Ce), praseodymium (Pr), neodymium (Nd), samarium (Sm), europium (Eu), gadolinium (Gd), terbium (Tb), dysprosium (Dy), holmium (Ho), erbium (Er), thulium (Tm), ytterbium (Yb), or lutetium (Lu) can be given.

As the oxide semiconductor included in the oxide semiconductor film, any of the following can be used: an In—Ga—Zn-based oxide, an In—Al—Zn-based oxide, an In—Sn—Zn-based oxide, an In—Hf—Zn-based oxide, an In—La—Zn-based oxide, an In—Ce—Zn-based oxide, an In—Pr—Zn-based oxide, an In—Nd—Zn-based oxide, an In—Sm—Zn-based oxide, an In—Eu—Zn-based oxide, an In—Gd—Zn-based oxide, an In—Tb—Zn-based oxide, an In—Dy—Zn-based oxide, an In—Ho—Zn-based oxide, an In—Er—Zn-based oxide, an In—Tm—Zn-based oxide, an In—Yb—Zn-based oxide, an In—Lu—Zn-based oxide, an In—Sn—Ga—Zn-based oxide, an In—Hf—Ga—Zn-based oxide, an In—Al—Ga—Zn-based oxide, an In—Sn—Al—Zn-based oxide, an In—Sn—Hf—Zn-based oxide, an In—Hf—Al—Zn-based oxide, and an In—Ga-based oxide.

Note that here, for example, an “In—Ga—Zn-based oxide” means an oxide containing In, Ga, and Zn as its main components and there is no limitation on the ratio of In to Ga and Zn. The In—Ga—Zn-based oxide may contain another metal element in addition to In, Ga, and Zn.

For example, a semiconductor layer containing polycrystalline silicon that is obtained by crystallization process such as laser annealing can be used in the transistor 502t and the transistor 503t illustrated in FIG. 7(B).

A structure of the case of using top-gate transistors in the display portion 501 is illustrated in FIG. 7(C).

For example, a semiconductor layer containing polycrystalline silicon, a single crystal silicon film that is transferred from a single crystal silicon substrate, or the like can be used in the transistor 502t and the transistor 503t illustrated in FIG. 7(C).

Note that this embodiment can be combined with any of the other embodiments described in this specification as appropriate.

### Embodiment 4

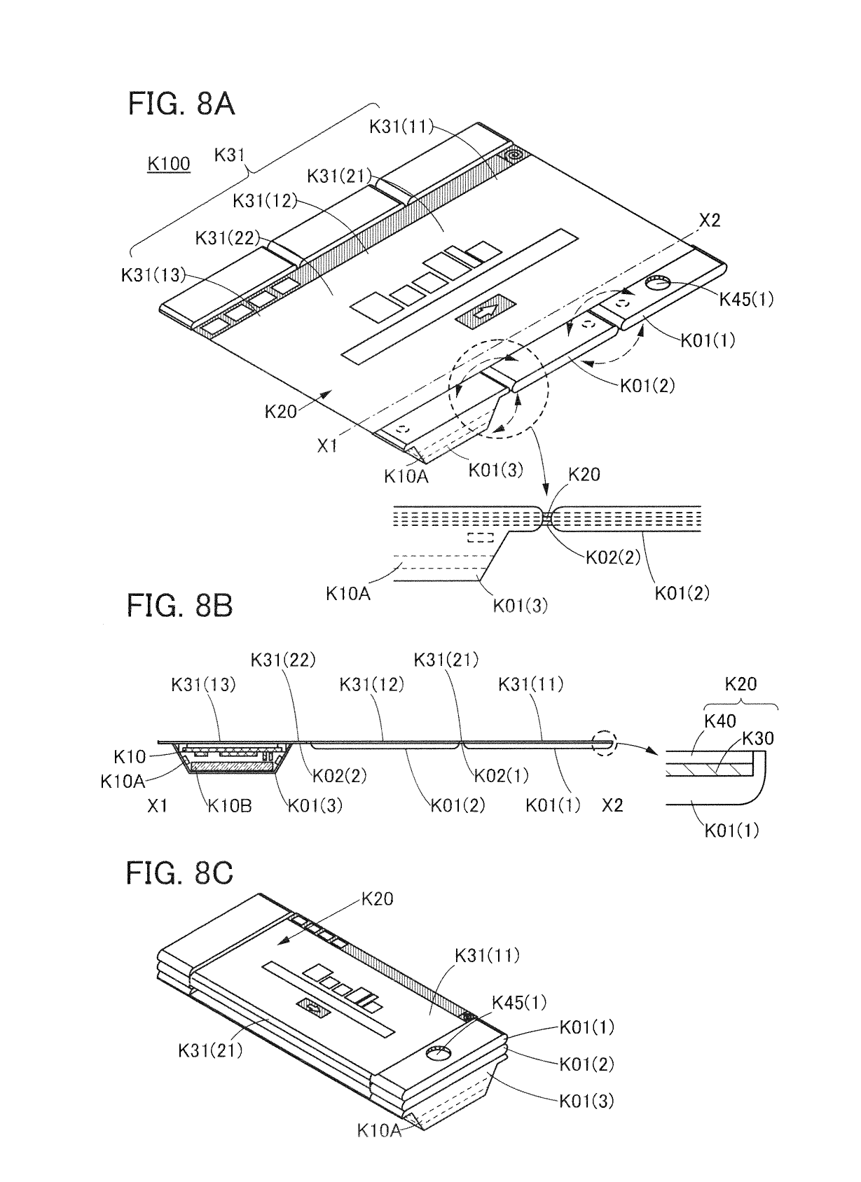

In this embodiment, a structure of a data processing device of one embodiment of the present invention is described with reference to FIG. 8.

FIG. 8 illustrates the data processing device of one embodiment of the present invention.

FIG. 8(A) is a projection view illustrating an input/output device K20 of a data processing device K100 of one embodiment of the present invention which is unfolded. FIG. 8(B) is a cross-sectional view of the data processing device K100 along cutting plane line X1-X2 in FIG. 8(A). FIG. 8(C) is a projection view illustrating the input/output device K20 that is folded.

### <Structure Example of Data Processing Device>

The data processing device K100 described in this embodiment includes the input/output device K20, an arithmetic device K10, and a housing K01(1) to a housing K01(3) (see FIG. 8).

### <<Input/Output Device>>

The input/output device K20 includes a display portion K30 and an input device K40. The input/output device K20 is supplied with the image data V and supplies the sensing data S. The display portion K30 is supplied with the image data V, and an input device K40 supplies the sensing data S (see FIG. 8(B)). The input/output device K20 in which the input device K40 and the display portion K30 overlap with each other as one body serves not only as the display portion K30 but also as the input device K40. Note that the input/output device K20 using a touch sensor as the input device K40 and a display panel as the display portion K30 is a touch panel. Furthermore, the input/output device K20 including the input/output device 500 described in Embodiment 3, and the housing (e.g., the housing K01(1)) electrically connected to the second electrode 12 of the input/output device 500 can be used. Thus, the control signal can be supplied to the second electrode 12 through the housing.

### <<Display Portion>>

The display portion K30 includes a region K31 where a first region K31(11), a first bendable region K31(21), a second region K31(12), a second bendable region K31(22), and a third region K31(13) are arranged in stripes in this order (see FIG. 8(A)).

The display portion K30 can be folded and unfolded along a first fold line formed in the first bendable region K31(21) and a second fold line formed in the second bendable region K31(22) (see FIG. 8(A) and FIG. 8(C)).

### <<Arithmetic Device>>

The arithmetic device K10 includes an arithmetic unit and a storage unit that stores a program to be executed by the arithmetic unit. In addition, it supplies the image data V and is supplied with the sensing data S.

### <<Housing>>

The housings include the housing K01(1), a hinge K02(1), the housing K01(2), a hinge K02(2), and the housing K01(3) which are placed in this order.

In the housing K01(3), the arithmetic device K10 is stored. In addition, the housing K01(1) to the housing K01(3) hold the input/output device K20 and enable the input/output device K20 to be folded and unfolded (see FIG. 8(B)).

In the example described in this embodiment, the data processing device has the three housings connected with one another with the two hinges. The data processing device having this structure can be folded with the input/output device K20 bent at two positions.

Note that n housings (n is a natural number of two or more) may be connected with one another with (n−1) hinges. The data processing device having this structure can be folded with the input/output device K20 bent at (n−1) positions.

The housing K01(1) overlaps with the first region K31(11) and is provided with a button K45(1).

The housing K01(2) overlaps with the second region K31(12).

The housing K01(3) overlaps with the third region K31(13) and stores the arithmetic device K10, an antenna K10A, and a battery K10B.

The hinge K02(1) overlaps with the first bendable region K31(21) and connects the housing K01(1) rotatably to the housing K01(2).

The hinge K02(2) overlaps with the second bendable region K31(22) and connects the housing K01(2) rotatably to the housing K01(3).

The antenna K10A is electrically connected to the arithmetic device K10 and supplies a signal or is supplied with a signal.

In addition, the antenna K10A is wirelessly supplied with power from an external device and supplies power to the battery K10B.

The battery K10B is electrically connected to the arithmetic device K10 and supplies power.

Note that as the folding sensor, a folding sensor determining whether the housing is folded or unfolded and supplying data showing the state of the housing can be used. Thus, the data showing the state of the housing K01 is supplied to the arithmetic device K10.

In the case where the data showing the state of the housing K01 is data showing a folded state, the arithmetic device K10 supplies the image data V including a first image to the first region K31(11) (see FIG. 8(C)).

In the case where the data showing the state of the housing K01 is data showing an unfolded state, the arithmetic device K10 supplies the image data V to the region K31 of the display portion K30 (see FIG. 8(A)).

Note that this embodiment can be combined with any of the other embodiments described in this specification as appropriate.

### Embodiment 5

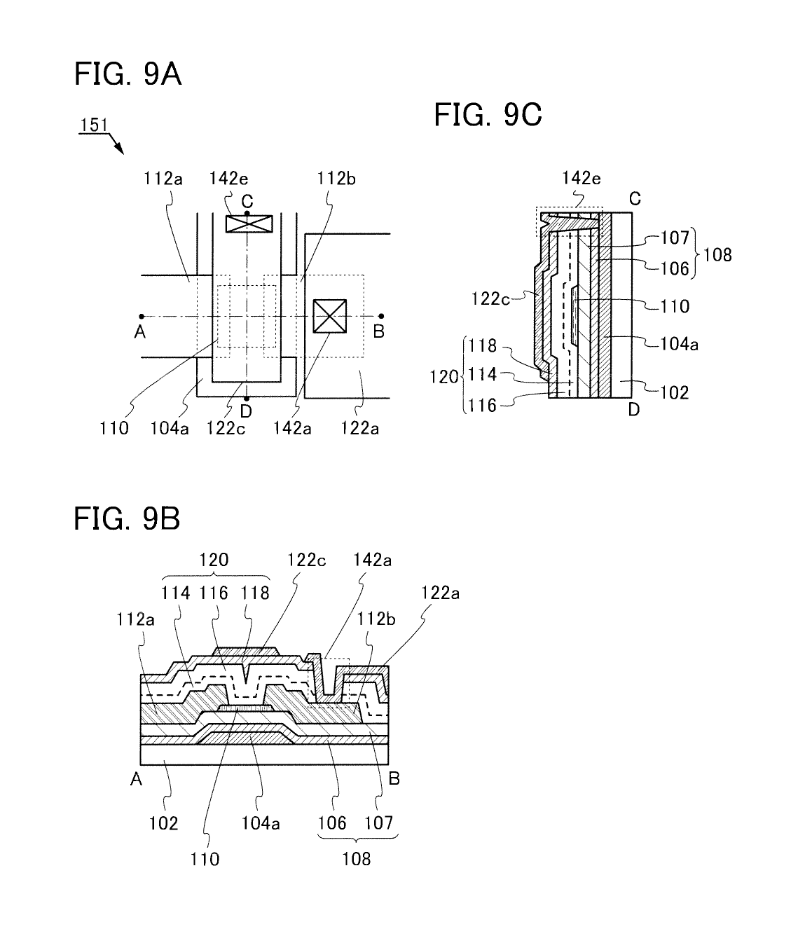

In this embodiment, a structure of a transistor that can be used in a sensor circuit 19 of one embodiment of the present invention or the like is described with reference to FIG. 9.

FIG. 9(A) to FIG. 9(C) are a top view and cross-sectional views of the transistor 151. FIG. 9(A) is a top view of the transistor 151, FIG. 9(B) is a cross-sectional view taken along dashed-dotted line A-B in FIG. 9(A), and FIG. 9(C) is a cross-sectional view taken along dashed-dotted line C-D in FIG. 9(A). Note that in FIG. 9(A), some components are not illustrated for clarity.

Note that in this embodiment, the first electrode refers to one of a source and a drain of a transistor, and the second electrode refers to the other.

The transistor 151 includes a gate electrode 104a provided over a substrate 102, a first insulating film 108 that includes insulating films 106 and 107 and is formed over the substrate 102 and the gate electrode 104a, an oxide semiconductor film 110 overlapping with the gate electrode 104a with the first insulating film 108 provided therebetween, and a first electrode 112a and a second electrode 112b in contact with the oxide semiconductor film 110.

In addition, over the first insulating film 108, the oxide semiconductor film 110, the first electrode 112a, and the second electrode 112b, a second insulating film 120 including insulating films 114, 116, and 118 and a gate electrode 122c formed over the second insulating film 120 are provided.

The gate electrode 122c is connected to the gate electrode 104a in an opening portion 142e provided in the first insulating film 108 and the second insulating film 120. In addition, a conductive film 122a serving as a pixel electrode is formed over the insulating film 118. The conductive film 122a is connected to the second electrode 112b through an opening portion 142a provided in the second insulating film 120.

Note that the first insulating film 108 serves as a first gate insulating film of the transistor 151, and the second insulating film 120 serves as a second gate insulating film of the transistor 151. Furthermore, the conductive film 122a serves as a pixel electrode.

In the transistor 151 of one embodiment of the present invention, in the channel width direction, the oxide semiconductor film 110 between the first insulating film 108 and the second insulating film 120 is provided between the gate electrode 104a and the gate electrode 122c. In addition, as illustrated in FIG. 9(A), the gate electrode 104a overlaps with side surfaces of the oxide semiconductor film 110 with the first insulating film 108 provided therebetween, when seen from the above.

A plurality of opening portions is provided in the first insulating film 108 and the second insulating film 120. Typically, as illustrated in FIG. 9(B), the opening portion 142a through which part of the second electrode 112b is exposed is provided. Furthermore, the opening portion 142e is provided as illustrated in FIG. 9(C).

In the opening portion 142a, the second electrode 112b is connected to the conductive film 122a.

In addition, in the opening portion 142e, the gate electrode 104a is connected to the gate electrode 122c.

When the gate electrode 104a and the gate electrode 122c are included and the same potential is applied to the gate electrode 104a and the gate electrode 122c, carriers flow in a wide region in the oxide semiconductor film 110. Accordingly, the amount of carriers that move in the transistor 151 increases.

As a result, the on-state current of the transistor 151 is increased, and the field-effect mobility is increased to greater than or equal to 10 cm²/V·s or to greater than or equal to 20 cm²/V·s, for example. Note that here, the field-effect mobility is not an approximate value of the mobility as the physical property of the oxide semiconductor film but is the apparent field-effect mobility in a saturation region of the transistor, which is an indicator of current drive capability.

An increase in field-effect mobility becomes significant when the channel length (also referred to as L length) of the transistor is longer than or equal to 0.5 μm and shorter than or equal to 6.5 μm, preferably longer than 1 μm and shorter than 6 μm, further preferably longer than 1 μm and shorter than or equal to 4 μm, still further preferably longer than 1 μm and shorter than or equal to 3.5 μm, yet still further preferably longer than 1 μm and shorter than or equal to 2.5 μm. Furthermore, with a short channel length longer than or equal to 0.5 μm and shorter than or equal to 6.5 μm, the channel width can also be short.

The transistor includes the gate electrode 104a and the gate electrode 122c, each of which has a function of blocking an external electric field; thus, charges such as a charged particle between the substrate 102 and the gate electrode 104a and over the gate electrode 122c do not affect the oxide semiconductor film 110. Thus, degradation due to a stress test (e.g., −GBT (Gate Bias-Temperature) stress test in which a negative potential is applied to a gate electrode) can be reduced, and changes in the rising voltages of on-state current at different drain voltages can be suppressed.

The BT stress test is one kind of accelerated test and can evaluate, in a short time, change in characteristics (i.e., a change over time) of transistors, which is caused by long-term use. In particular, the amount of change in threshold voltage of a transistor between before and after the BT stress test is an important indicator when examining the reliability of the transistor. If the amount of change in the threshold voltage between before and after the BT stress test is small, the transistor has higher reliability.

The substrate 102 and individual components included in the transistor 151 are described below.

### <<Substrate 102>>

For the substrate 102, a glass material such as aluminosilicate glass, aluminoborosilicate glass, or barium borosilicate glass is used. In the mass production, for the substrate 102, a mother glass with any of the following sizes is preferably used: the 8-th generation (2160 mm×2460 mm), the 9-th generation (2400 mm×2800 mm or 2450 mm×3050 mm), the 10-th generation (2950 mm×3400 mm), and the like. High process temperature and a long period of process time drastically shrink the mother glass. Thus, in the case where mass production is performed with the use of the mother glass, it is preferable that the heat process in the manufacturing process be performed at a temperature lower than or equal to 600° C., preferably lower than or equal to 450° C., further preferably lower than or equal to 350° C.

<<Gate Electrode 104a>>

As a material used for the gate electrode 104a, a metal element selected from aluminum, chromium, copper, tantalum, titanium, molybdenum, and tungsten, an alloy containing any of these metal elements as a component, an alloy containing these metal elements in combination, or the like can be used. The material used for the gate electrode 104a may have a single-layer structure or a stacked-layer structure of two or more layers. For example, a two-layer structure in which a titanium film is stacked over an aluminum film, a two-layer structure in which a titanium film is stacked over a titanium nitride film, a two-layer structure in which a tungsten film is stacked over a titanium nitride film, a two-layer structure in which a tungsten film is stacked over a tantalum nitride film or a tungsten nitride film, a three-layer structure including a titanium film, an aluminum film stacked over the titanium film, and a titanium film further ft:limed thereover, and the like can be given. With aluminum, a film of an element selected from titanium, tantalum, tungsten, molybdenum, chromium, neodymium, and scandium, an alloy film in which a plurality of elements selected from titanium, tantalum, tungsten, molybdenum, chromium, neodymium, and scandium are combined, or a nitride film containing an element selected from titanium, tantalum, tungsten, molybdenum, chromium, neodymium, and scandium may be used. The material used for the gate electrode 104a can be formed by a sputtering method, for example.

### <<First Insulating Film 108>>

An example in which the first insulating film 108 has a two-layer structure of the insulating film 106 and the insulating film 107 is illustrated. Note that the structure of the first insulating film 108 is not limited thereto, and for example, a single-layer structure or a stacked-layer structure including three or more layers may be employed.

The insulating film 106 is formed with a single-layer structure or a stacked-layer structure using, for example, any of a silicon nitride oxide film, a silicon nitride film, an aluminum oxide film, and the like with a PE-CVD apparatus. In the case where the insulating film 106 has a stacked-layer structure, it is preferable that a silicon nitride film with fewer defects be provided as a first silicon nitride film, and a silicon nitride film from which hydrogen and ammonia are less likely to be released be provided over the first silicon nitride film, as a second silicon nitride film. As a result, hydrogen and nitrogen contained in the insulating film 106 can be inhibited from moving or diffusing into the oxide semiconductor film 110 to be formed later.

The insulating film 107 is formed with a single-layer structure or a stacked-layer structure using any of a silicon oxide film, a silicon oxynitride film, and the like with a PE-CVD apparatus.

The first insulating film 108 can have a stacked-layer structure, for example, in which a 400-nm-thick silicon nitride film used as the insulating film 106 and a 50-nm-thick silicon oxynitride film used as the insulating film 107 are formed in this order. The silicon nitride film and the silicon oxynitride film are preferably formed in succession in a vacuum, in which case entry of impurities is suppressed. The first insulating film 108 in a position overlapping with the gate electrode 104a serves as a gate insulating film of the transistor 151. Note that silicon nitride oxide refers to an insulating material that contains more nitrogen than oxygen, whereas silicon oxynitride refers to an insulating material that contains more oxygen than nitrogen.

### <<Oxide Semiconductor Film 110>>

For the oxide semiconductor film 110 an oxide semiconductor is preferably used. As the oxide semiconductor, a film represented by an In-M-Zn oxide that contains at least indium (In), zinc (Zn), and M (a metal such as Al, Ga, Ge, Y, Zr, Sn, La, Ce, or Hf) is preferably included. Alternatively, both In and Zn are preferably contained. In order to reduce fluctuations in electrical characteristics of the transistors including the oxide semiconductor, the oxide semiconductor preferably contains a stabilizer in addition to them.

As a stabilizer, gallium (Ga), tin (Sn), hafnium (Hf), aluminum (Al), zirconium (Zr), and the like can be given. As another stabilizer, lanthanoid such as lanthanum (La), cerium (Ce), praseodymium (Pr), neodymium (Nd), samarium (Sm), europium (Eu), gadolinium (Gd), terbium (Tb), dysprosium (Dy), holmium (Ho), erbium (Er), thulium (Tm), ytterbium (Yb), or lutetium (Lu) can be given.

As the oxide semiconductor included in the oxide semiconductor film 110, any of the following can be used: an In—Ga—Zn-based oxide, an In—Al—Zn-based oxide, an In—Sn—Zn-based oxide, an In—Hf—Zn-based oxide, an In—La—Zn-based oxide, an In—Ce—Zn-based oxide, an In—Pr—Zn-based oxide, an In—Nd—Zn-based oxide, an In—Sm—Zn-based oxide, an In—Eu—Zn-based oxide, an In—Gd—Zn-based oxide, an In—Tb—Zn-based oxide, an In—Dy—Zn-based oxide, an In—Ho—Zn-based oxide, an In—Er—Zn-based oxide, an In—Tm—Zn-based oxide, an In—Yb—Zn-based oxide, an In—Lu—Zn-based oxide, an In—Sn—Ga—Zn-based oxide, an In—Hf—Ga—Zn-based oxide, an In—Al—Ga—Zn-based oxide, an In—Sn—Al—Zn-based oxide, an In—Sn—Hf—Zn-based oxide, and an In—Hf—Al—Zn-based oxide.

Note that here, for example, an “In—Ga—Zn-based oxide” means an oxide containing In, Ga, and Zn as its main components and there is no limitation on the ratio of In to Ga and Zn. The In—Ga—Zn-based oxide may contain another metal element in addition to In, Ga, and Zn.

The oxide semiconductor film 110 can be formed by a sputtering method, a molecular beam epitaxy (MBE) method, a CVD method, a pulse laser deposition method, an atomic layer deposition (ALD) method, or the like as appropriate. In particular, the oxide semiconductor film 110 is preferably formed by the sputtering method because a dense can be formed.

In the formation of an oxide semiconductor film as the oxide semiconductor film 110, the hydrogen concentration in the oxide semiconductor film is preferably reduced as much as possible. To reduce the hydrogen concentration, for example, in the case of a sputtering method, a deposition chamber needs to be highly evacuated and also a sputtering gas needs to be highly purified. As an oxygen gas or an argon gas used for a sputtering gas, a gas which is highly purified to have a dew point of −40° C. or lower, preferably −80° C. or lower, further preferably −100° C. or lower, or still further preferably −120° C. or lower is used, whereby entry of moisture or the like into the oxide semiconductor film can be minimized.

In order to remove moisture remaining in the deposition chamber, an entrapment vacuum pump, such as a cryopump, an ion pump, or a titanium sublimation pump, is preferably used. A turbo molecular pump provided with a cold trap may be alternatively used. Because the deposition chamber evacuated with a cryopump has a high capability in removing a hydrogen molecule, a compound containing a hydrogen atom such as water (H₂O) (preferably, also a compound containing a carbon atom), and the like, the concentration of an impurity to be contained in a film formed in the deposition chamber evacuated with this can be reduced.

When the oxide semiconductor film as the oxide semiconductor film 110 is formed by a sputtering method, the relative density (filling factor) of a metal oxide target that is used for the film formation is greater than or equal to 90% and less than or equal to 100%, preferably greater than or equal to 95% and less than or equal to 100%. With the use of the metal oxide target having high relative density, a dense oxide semiconductor film can be formed.

Note that to reduce the impurity concentration of the oxide semiconductor film, it is also effective to form the oxide semiconductor film as the oxide semiconductor film 110 while the substrate 102 is kept at high temperature. The heating temperature of the substrate 102 may be higher than or equal to 150° C. and lower than or equal to 450° C., and preferably the substrate temperature is higher than or equal to 200° C. and lower than or equal to 350° C.

Next, first heat treatment is preferably performed. The first heat treatment may be performed at a temperature higher than or equal to 250° C. and lower than or equal to 650° C., preferably higher than or equal to 300° C. and lower than or equal to 500° C., in an inert gas atmosphere, an atmosphere containing an oxidizing gas at 10 ppm or more, or a reduced pressure state. Alternatively, the first heat treatment may be performed in such a manner that heat treatment is performed in an inert gas atmosphere, and then another heat treatment is performed in an atmosphere containing an oxidizing gas at 10 ppm or more, in order to compensate for desorbed oxygen. By the first heat treatment, the crystallinity of the oxide semiconductor that is used as the oxide semiconductor film 110 can be improved, and in addition, impurities such as hydrogen and water can be removed from the first insulating film 108 and the oxide semiconductor film 110. The first heat treatment may be performed before the oxide semiconductor film 110 is processed into an island shape.

### <<First Electrode and Second Electrode>>

The first electrode 112a and the second electrode 112b can be formed using a conductive film 112 having a single-layer structure or a stacked-layer structure with any of metals such as aluminum, titanium, chromium, nickel, copper, yttrium, zirconium, molybdenum, silver, tantalum, and tungsten, or an alloy containing any of these metals as its main component. In particular, one or more elements selected from aluminum, chromium, copper, tantalum, titanium, molybdenum, and tungsten are preferably included. For example, a two-layer structure in which a titanium film is stacked over an aluminum film, a two-layer structure in which a titanium film is stacked over a tungsten film, a two-layer structure in which a copper film is formed over a copper-magnesium-aluminum alloy film, a three-layer structure in which a titanium film or a titanium nitride film, an aluminum film or a copper film, and a titanium film or a titanium nitride film are stacked in this order, a three-layer structure in which a molybdenum film or a molybdenum nitride film, an aluminum film or a copper film, and a molybdenum film or a molybdenum nitride film are stacked in this order, and the like can be given. Note that a transparent conductive material containing indium oxide, tin oxide, or zinc oxide may be used. The conductive film can be formed by a sputtering method, for example.

### <<Insulating Films 114 and 116>>

An example in which the second insulating film 120 has a three-layer structure of the insulating films 114, 116, and 118 is illustrated. Note that the structure of the second insulating film 120 is not limited thereto, and for example, a single-layer structure or a stacked-layer structure including two layers or four or more layers may be employed.

For the insulating films 114 and 116, an inorganic insulating material containing oxygen can be used in order to improve the characteristics of the interface with the oxide semiconductor used for the oxide semiconductor film 110. As examples of the inorganic insulating material containing oxygen, a silicon oxide film, a silicon oxynitride film, and the like can be given. The insulating films 114 and 116 can be formed by a PE-CVD method, for example.

The thickness of the insulating film 114 can be greater than or equal to 5 nm and less than or equal to 150 nm, preferably greater than or equal to 5 nm and less than or equal to 50 nm, more preferably greater than or equal to 10 nm and less than or equal to 30 nm. The thickness of the insulating film 116 can be greater than or equal to 30 nm and less than or equal to 500 nm, preferably greater than or equal to 150 nm and less than or equal to 400 nm.

Furthermore, the insulating films 114 and 116 can be formed using insulating films formed of the same kinds of materials; thus, a boundary between the insulating films 114 and 116 cannot be clearly observed in some cases. Thus, in this embodiment, the boundary between the insulating films 114 and 116 is shown by a dashed line. Although a two-layer structure of the insulating films 114 and 116 is described in this embodiment, the present invention is not limited to this. For example, a single-layer structure of the insulating film 114, a single-layer structure of the insulating film 116, or a stacked-layer structure including three or more layers may be used.

The insulating film 118 is a film formed using a material that can prevent an external impurity, such as water, alkali metal, or alkaline earth metal, from diffusing into the oxide semiconductor film 110, and that further contains hydrogen.

For example, a silicon nitride film, a silicon nitride oxide film, or the like having a thickness of greater than or equal to 150 nm and less than or equal to 400 nm can be used as the insulating film 118. In this embodiment, a 150-nm-thick silicon nitride film is used as the insulating film 118.

The silicon nitride film is preferably formed at a high temperature to have an improved blocking property against impurities or the like; for example, the silicon nitride film is preferably formed at a substrate temperature greater than or equal to 100° C. and less than or equal to the strain point of the substrate, more preferably at a temperature greater than or equal to 300° C. and less than or equal to 400° C. When the silicon nitride film is formed at a high temperature, a phenomenon in which oxygen is released from the oxide semiconductor used for the oxide semiconductor film 110 and the carrier concentration is increased is caused in some cases; therefore, the upper limit of the temperature is a temperature at which the phenomenon is not caused.

<<Conductive Film 122a and Gate Electrode 122c>>

For the conductive film used as the conductive film 122a and the gate electrode 122c, an oxide containing indium may be used. For example, a light-transmitting conductive material such as indium oxide containing tungsten oxide, indium zinc oxide containing tungsten oxide, indium oxide containing titanium oxide, indium tin oxide containing titanium oxide, indium tin oxide (hereinafter referred to as ITO), indium zinc oxide, or indium tin oxide to which silicon oxide is added can be used. The conductive film that can be used as the conductive films 122a and 122b can be formed by a sputtering method, for example.

Note that the structures, methods, and the like described in this embodiment can be used as appropriate in combination with any of the structures, methods, and the like described in the other embodiments.

### Embodiment 6

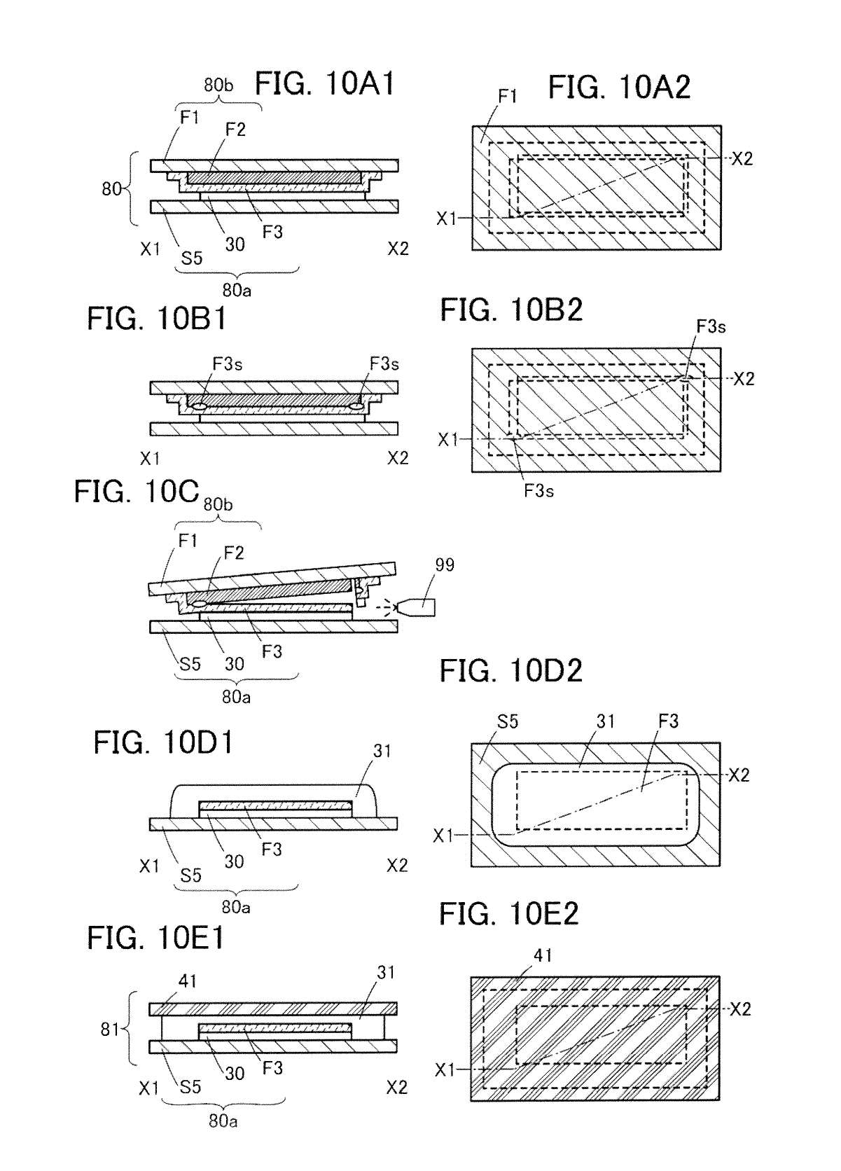

In this embodiment, a method of manufacturing a stack that can be used in the sensor or input/output device of one embodiment of the present invention is described with reference to FIG. 10.

FIG. 10 illustrates schematic views of a process of manufacturing the stack. Cross-sectional views illustrating structures of a processed member and the stack are shown on the left side of FIG. 10, and top views corresponding to the cross-sectional views except FIG. 10(C) are shown on the right side.

### <Manufacturing Method of Stack>

A method of manufacturing a stack 81 from a processed member 80 is described with reference to FIG. 10.

The processed member 80 includes a first substrate F1, a first separation layer F2 on the first substrate F1, a first layer F3 to be separated whose one surface is in contact with the first separation layer F2, a bonding layer 30 whose one surface is in contact with the other surface of the first layer F3 to be separated, and a base layer S5 in contact with the other surface of the bonding layer 30 (see FIG. 10(A-1) and FIG. 10(A-2)).

Note that a structure of the processed member 80 is described in detail in Embodiment 8.

### <<Formation of SEPARATION STARTING POINTS>>

The processed member 80 in which separation starting points F3s are formed in the vicinity of edges of the bonding layer 30 is prepared.

The separation starting points F3s are formed by separating part of the first layer F3 to be separated, from the first substrate F1.

Part of the first layer F3 to be separated can be separated from the separation layer F2 by inserting a sharp tip into the first layer F3 to be separated, from the first substrate F1 side, or by a method using a laser or the like (e.g., a laser ablation method). Thus, the separation starting point F3s can be formed.

### <<First Step>>

The processed member 80 in which the separation starting points F3s are formed in the vicinity of the edges of the bonding layer 30 in advance is prepared (see FIG. 10(B-1) and FIG. 10(B-2)).

### <<Second Step>>

One surface layer 80b of the processed member 80 is separated. As a result, a first remaining portion 80a is obtained from the processed member 80.

Specifically, from the separation starting point F3s formed in the vicinity of the edge of the bonding layer 30, the first substrate F1, together with the first separation layer F2, is separated from the first layer F3 to be separated (see FIG. 10(C)). Consequently, the first remaining portion 80a including the first layer F3 to be separated, the bonding layer 30 whose one surface is in contact with the first layer F3 to be separated, and the base layer S5 in contact with the other surface of the bonding layer 30 is obtained.

Note that the separation may be performed while the vicinity of the interface between the separation layer F2 and the layer F3 to be separated is irradiated with ions to remove static electricity. Specifically, the ions may be generated by an ionizer.

Furthermore, when the layer to be separated is separated from the separation layer F2, a liquid is injected into the interface between the separation layer F2 and the layer F3 to be separated. Alternatively, a liquid may be ejected and sprayed by a nozzle 99. For example, as the injected liquid or the sprayed liquid, water, a polar solvent, or the like can be used.

By injecting the liquid, an influence of static electricity and the like generated with the separation can be reduced. Alternatively, the separation may be performed while a liquid that dissolves the separation layer is injected.

In particular, in the case where a film containing tungsten oxide is used as the separation layer F2, the first layer F3 to be separated is preferably separated while a liquid containing water is injected or sprayed because a stress applied to the first layer F3 to be separated due to the separation can be reduced.

### <<Third Step>>

A first adhesive layer 31 is formed on the first remaining portion 80a and the first remaining portion 80a is bonded to a first support 41 with the first adhesive layer 31 (see FIG. 10(D-1) and FIG. 10(D-2)). Consequently, the stack 81 is obtained from the first remaining portion 80a.

Specifically, the stack 81 including the first support 41, the first adhesive layer 31, the first layer F3 to be separated, the bonding layer 30 whose one surface is in contact with the first layer F3 to be separated, and the base layer S5 in contact with the other surface of the bonding layer 30 is obtained (see FIG. 10(E-1) and FIG. 10(E-2)).

To form the bonding layer 30, any of a variety of methods can be used. For example, the bonding layer 30 can be formed with a dispenser, by a screen printing method, or the like. The bonding layer 30 is cured by a method selected depending on the material of the bonding layer 30. For example, when a light curable adhesive is used for the bonding layer 30, light including light having a predetermined wavelength is emitted.

Note that this embodiment can be combined with any of the other embodiments described in this specification as appropriate.

### Embodiment 7

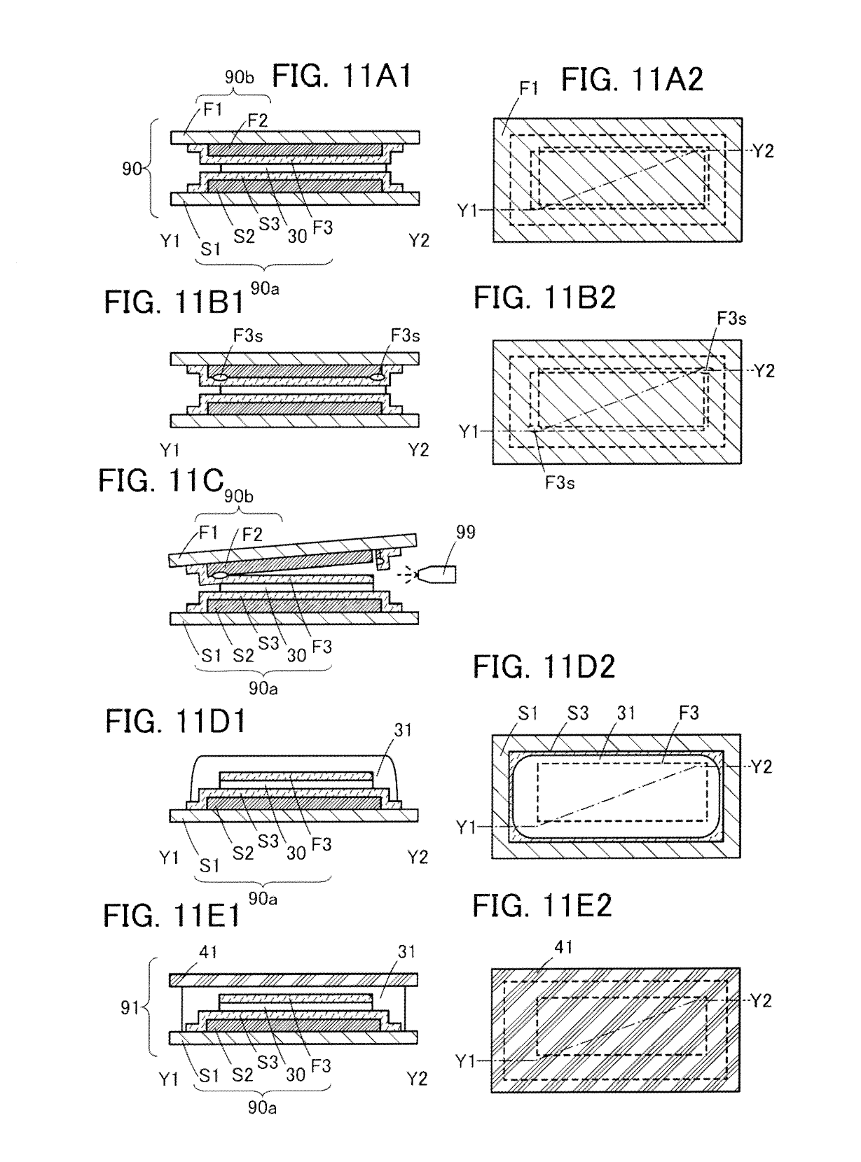

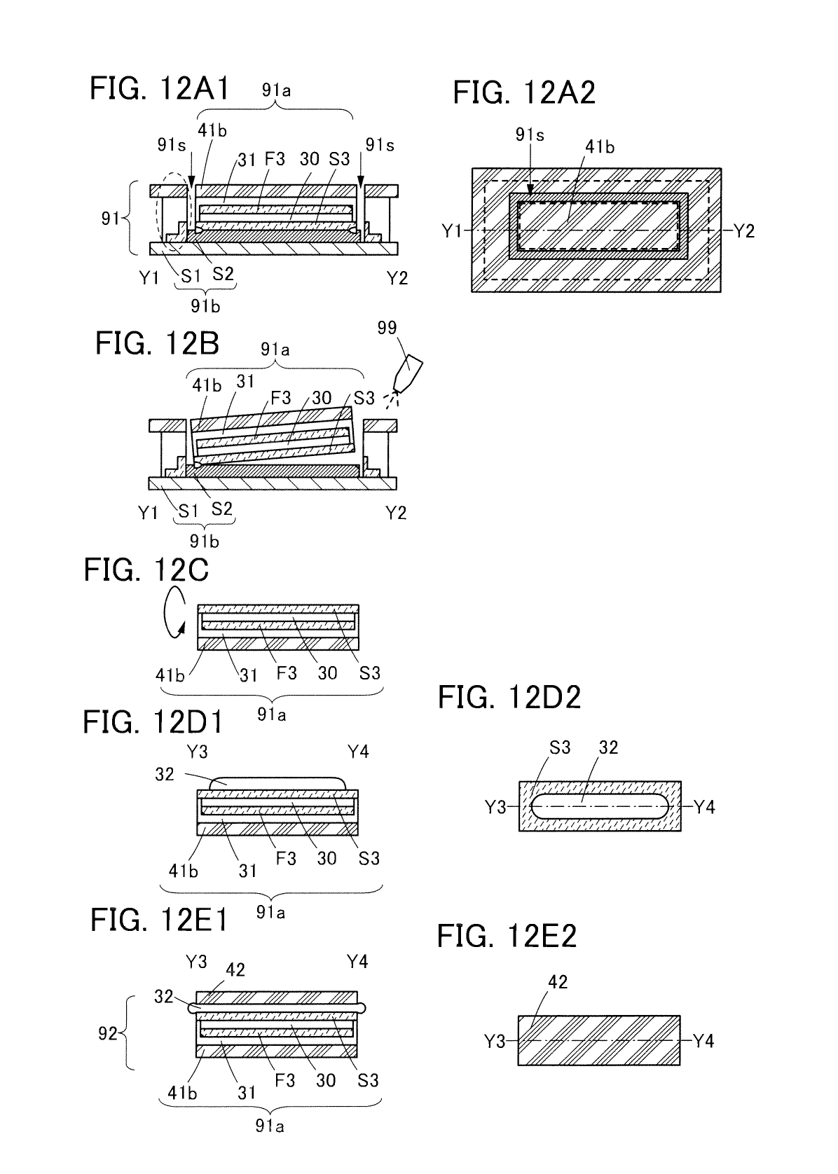

In this embodiment, a method of manufacturing a stack that can be used in the manufacture of the input device or input/output device of one embodiment of the present invention is described with reference to FIG. 11 and FIG. 12.

FIG. 11 and FIG. 12 are schematic views illustrating a process of manufacturing the stack. Cross-sectional views illustrating structures of a processed member and the stack are shown on the left side of FIG. 11 and FIG. 12, and top views corresponding to the cross-sectional views except FIG. 11(C), FIG. 12(B), and FIG. 12(C) are shown on the right side.

### <Manufacturing Method of Stack>

A method of manufacturing a stack 92 from a processed member 90 is described with reference to FIG. 11 and FIG. 12.

The processed member 90 is different from the processed member 80 in that the other surface of the bonding layer 30 is in contact with one surface of a second layer S3 to be separated instead of the material S5.

Specifically, the difference is that the second substrate S1 instead of the base layer S5, a second separation layer S2 over the second substrate S1, and the second layer S3 to be separated whose other surface is in contact with the second separation layer S2 are included, and that one surface of the second layer S3 to be separated is in contact with the other surface of the bonding layer 30.

In the processed member 90, the first substrate F1, the first separation layer F2, the first layer F3 to be separated whose one surface is in contact with the first separation layer F2, the bonding layer 30 whose one surface is in contact with the other surface of the first layer F3 to be separated, the second layer S3 to be separated whose one surface is in contact with the other surface of the bonding layer 30, the second separation layer S2 whose one surface is in contact with the other surface of the second layer S3 to be separated, and the second substrate S1 are placed in this order (see FIG. 11(A-1) and FIG. 11(A-2)).

Note that a structure of the processed member 90 is described in detail in Embodiment 8.

### <<First Step>>

The processed member 90 in which the separation starting points F3s are formed in the vicinity of the edges of the bonding layer 30 is prepared (see FIG. 11(B-1) and FIG. 11(B-2)).

The separation starting point F3s is formed by separating part of the first layer F3 to be separated, from the first substrate F1.

For example, part of the first layer F3 to be separated can be separated from the separation layer F2 by inserting a sharp tip into the first layer F3 to be separated, from the first substrate F1 side, or by a method using a laser or the like (e.g., a laser ablation method). Thus, the separation starting point F3s can be formed.

### <<Second Step>>

One surface layer 90b of the processed member 90 is separated. As a result, a first remaining portion 90a is obtained from the processed member 90.

Specifically, from the separation starting point F3s formed in the vicinity of the edge of the bonding layer 30, the first substrate F1, together with the first separation layer F2, is separated from the first layer F3 to be separated (see FIG. 11(C)). Consequently, the first remaining portion 90a in which the first layer F3 to be separated, the bonding layer 30 whose one surface is in contact with the first layer F3 to be separated, the second layer S3 to be separated whose one surface is in contact with the other surface of the bonding layer 30, the second separation layer S2 whose one surface is in contact with the other surface of the second layer S3 to be separated, and the second substrate S1 are placed in this order is obtained.

Note that the separation may be performed while the vicinity of the interface between the separation layer S2 and the layer S3 to be separated is irradiated with ions to remove static electricity. Specifically, the ions may be generated by an ionizer.

Furthermore, when the layer to be separated is separated from the separation layer S2, a liquid is injected into the interface between the separation layer S2 and the layer S3 to be separated. Alternatively, a liquid may be ejected and sprayed by a nozzle 99. For example, as the liquid to be injected or the liquid to be sprayed, water, a polar solvent, or the like can be used.

By injecting the liquid, an influence of static electricity and the like generated with the separation can be reduced. Alternatively, the separation may be performed while a liquid that dissolves the separation layer is injected.

In particular, in the case where a film containing tungsten oxide is used as the separation layer S2, the first layer S3 to be separated is preferably separated while a liquid containing water is injected or sprayed because a stress applied to the first layer S3 to be separated due to the separation can be reduced.

### <<Third Step>>

A first adhesive layer 31 is formed on the first remaining portion 90a (see FIG. 11(D-1) and FIG. 11(D-2)), and the first remaining portion 90a is bonded to a first support 41 with the first adhesive layer 31. Consequently, a stack 91 is obtained from the first remaining portion 90a.

Specifically, the stack 91 in which the first support 41, the first adhesive layer 31, the first layer F3 to be separated, the bonding layer 30 whose one surface is in contact with the first layer F3 to be separated, the second layer S3 to be separated whose one surface is in contact with the other surface of the bonding layer 30, the second separation layer S2 whose one surface is in contact with the other surface of the second layer S3 to be separated, and the second substrate S1 are placed in this order is obtained (see FIG. 11(E-1) and FIG. 11(E-2)).

### <<Sixth Step>>

Part of the second layer S3 to be separated in the vicinity of the edge of the first adhesive layer 31 of the stack 91 is separated from the second substrate S1 to form a second separation starting point 91s.

For example, the first support 41 and the first adhesive layer 31 are cut from the first support 41 side, and part of the second layer S3 to be separated is separated from the second substrate S1 along an edge of the first adhesive layer 31 which is newly formed.

Specifically, the first adhesive layer 31 and the first support 41 in a region which is over the separation layer S2 and in which the second layer S3 to be separated is provided are cut with a blade or the like including a sharp tip, and along a newly formed edge of the first adhesive layer 31, the second layer S3 to be separated is partly separated from the second substrate 51 (see FIG. 12(A-1) and FIG. 12(A-2)).

Consequently, the separation starting points 91s are formed in the vicinity of newly formed edges of the first support 41b and the first adhesive layer 31.

### <<Seventh Step>>

A second remaining portion 91a is separated from the stack 91. As a result, the second remaining portion 91a is obtained from the stack 91 (see FIG. 12C).

Specifically, from the separation starting point 91s formed in the vicinity of the edge of the first adhesive layer 31, the second substrate S1, together with the second separation layer S2, is separated from the second layer S3 to be separated. Consequently, the second remaining portion 91a in which the first support 41b, the first adhesive layer 31, the first layer F3 to be separated, the bonding layer 30 whose one surface is in contact with the first layer F3 to be separated, and the second layer S3 to be separated whose one surface is in contact with the other surface of the bonding layer 30 are placed in this order is obtained.

Note that the separation may be performed while the vicinity of the interface between the separation layer S2 and the layer S3 to be separated is irradiated with ions to remove static electricity. Specifically, the ions may be generated by an ionizer.

Furthermore, when the layer to be separated is separated from the second separation layer S2, a liquid is injected into the interface between the second separation layer S2 and the layer S3 to be separated. Alternatively, a liquid may be ejected and sprayed by a nozzle 99. For example, as the liquid to be injected or the liquid to be sprayed, water, a polar solvent, or the like can be used.

By injecting the liquid, an influence of static electricity and the like generated with the separation can be reduced. Alternatively, the separation may be performed while a liquid that dissolves the separation layer is injected.

In particular, in the case where a film containing tungsten oxide is used as the separation layer S2, the layer S3 to be separated is preferably separated while a liquid containing water is injected or sprayed because a stress applied to the layer S3 to be separated due to the separation can be reduced.

### <<Ninth Step>>

A second adhesive layer 32 is formed on the second remaining portion 91a (see FIG. 12(D-1) and FIG. 12(D-2)).

The second remaining portion 91a is bonded to the second support 42 with the second adhesive layer 32. Consequently, a stack 92 is obtained from the second remaining portion 91a (see FIG. 12(E-1) and FIG. 12(E-2)).

Specifically, the stack 92 in which first support 41b, the first adhesive layer 31, the first layer F3 to be separated, the bonding layer 30 whose one surface is in contact with the first layer F3 to be separated, the second layer S3 to be separated whose one surface is in contact with the other surface of the bonding layer 30, the second adhesive layer 32, and the second support 42 are placed in this order is obtained.

### <Manufacturing Methods of Stacks Including Opening Portion in Support>

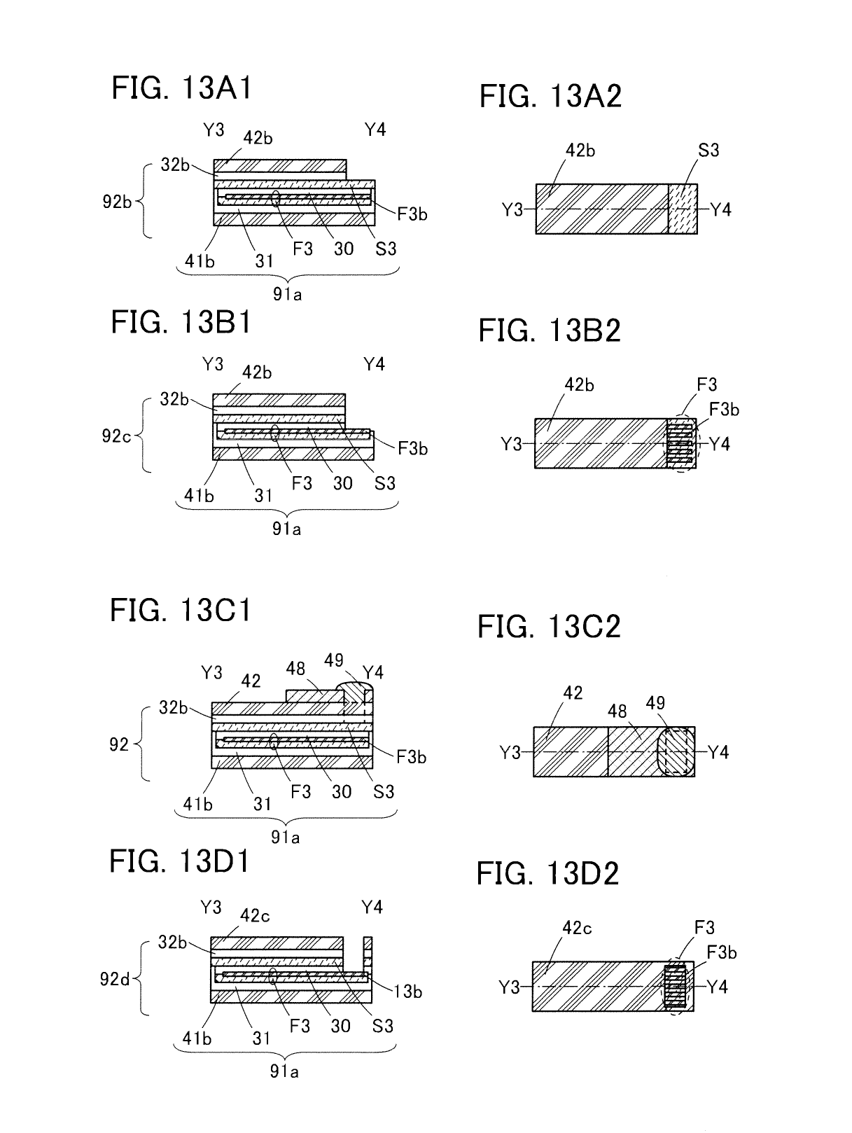

Methods of manufacturing stacks including an opening portion in a support are described with reference to FIG. 13.

FIG. 13 illustrates the methods of manufacturing stacks including an opening portion which exposes part of a layer to be separated in a support. Cross-sectional views illustrating structures of the stack are shown on the left side of FIG. 13, and top views corresponding to the cross-sectional views are shown on the right side.

FIG. 13(A-1) to FIG. 13(B-2) illustrate a method of manufacturing a stack 92c including an opening portion by using a second support 42b which is smaller than the first support 41b.

FIG. 13(C-1) to FIG. 13(D-2) illustrate a method of manufacturing a stack 92d including an opening portion formed in the second support 42.

### EXAMPLE 1 OF METHOD OF MANUFACTURING STACK INCLUDING OPENING PORTION IN SUPPORT

A method of manufacturing a stack has the same step as the above ninth step except that the second support 42b which is smaller than the first support 41b is used instead of the second support 42. By this method, a stack in which part of the second layer S3 to be separated is exposed can be manufactured (see FIG. 13(A-1) and FIG. 13 (A-2)).

As the second adhesive layer 32, a liquid adhesive can be used. Alternatively, an adhesive whose fluidity is inhibited and which is formed in a single wafer shape in advance (also referred to as a sheet-like adhesive) can be used. By using the sheet-like adhesive, the amount of part of the adhesive layer 32 which extends beyond the second support 42b can be small. In addition, the adhesive layer 32 can have a uniform thickness easily.

Part of the exposed part of the second layer S3 to be separated is cut off, and the first layer F3 to be separated may be exposed (see FIG. 13(B-1) and FIG. 13(B-2)).

Specifically, with a blade or the like which has a sharp tip, a slit is formed in the exposed second layer S3 to be separated. Then, for example, an adhesive tape or the like is attached to part of the exposed second layer S3 to be separated to concentrate stress near the slit, and the part of the exposed second layer S3 to be separated is separated together with the attached tape or the like, whereby the part can be selectively removed.

Moreover, a layer which can suppress the bonding power of the bonding layer 30 to the first layer F3 to be separated may be selectively formed on part of the first layer F3 to be separated. For example, a material which is not easily bonded to the bonding layer 30 may be selectively formed. Specifically, an organic material may be deposited into an island shape. Thus, part of the bonding layer 30 can be selectively removed together with the second layer S3 to be separated easily. As a result, the first layer F3 to be separated can be exposed.

Note that for example, in the case where the first layer F3 to be separated includes a functional layer and a conductive layer F3b electrically connected to the functional layer, the conductive layer F3b can be exposed in an opening portion in the second stack 92c. Thus, the conductive layer F3b exposed in the opening portion can be used as a terminal supplied with a signal.

As a result, the conductive layer F3b part of which is exposed in the opening portion can be used as a terminal from which a signal supplied though the functional layer can be extracted, or can be used as a terminal through which a signal supplied to the functional layer can be supplied by an external device.

### EXAMPLE 2 OF METHOD OF MANUFACTURING STACK INCLUDING OPENING PORTION IN SUPPORT

A mask 48 including an opening portion formed to overlap with an opening portion formed in the second support 42 is formed on the stack 92. Next, a solvent 49 is dropped into the opening portion in the mask 48. Thus, with the solvent 49, the second support 42 exposed in the opening portion in the mask 48 can be swelled or dissolved (see FIG. 13(C-1) and FIG. 13(C-2)).

After the extra solvent 49 is removed, stress is applied by, for example, rubbing the second support 42 exposed in the opening portion in the mask 48. Thus, the second support 42 or the like in a portion overlapping with the opening portion in the mask 48 can be removed.

Moreover, with a solvent with which the bonding layer 30 is swelled or dissolved, the first layer F3 to be separated can be exposed (see FIG. 13(D-1) and FIG. 13(D-2)).

This embodiment can be combined with any of the other embodiments described in this specification as appropriate.

### Embodiment 8

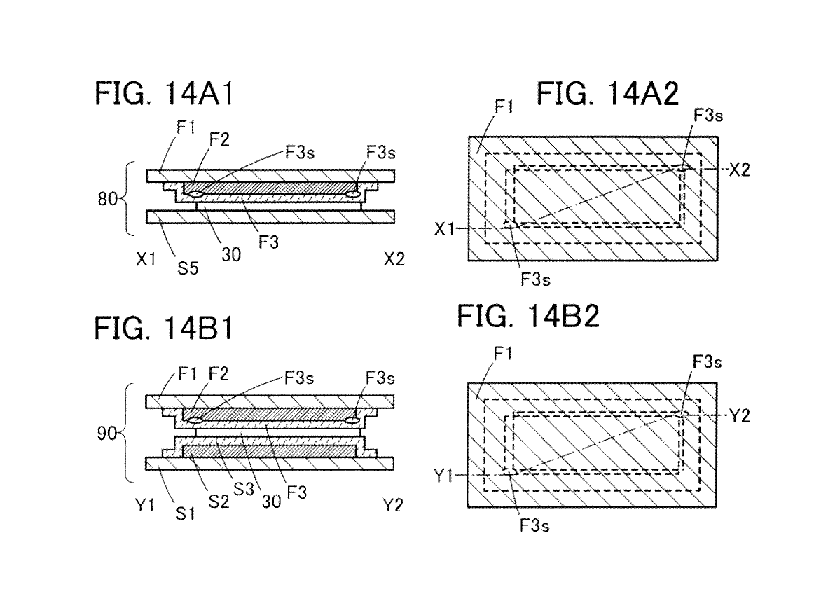

In this embodiment, structures of a processed members that can be processed into the stack that can be used in the input/output device of one embodiment of the present invention is described with reference to FIG. 14.

FIG. 14 illustrates schematic views of the structures of the processed members that can be processed into the stack.

FIG. 14(A-1) is a cross-sectional view illustrating the structure of the processed member 80 which can be processed into the stack, and FIG. 14(A-2) is a top view corresponding to the cross-sectional view.

FIG. 14(B-1) is a cross-sectional view illustrating the structure of the processed member 90 which can be processed into the stack, and FIG. 14(B-2) is a top view corresponding to the cross-sectional view.

### <1. Structure Example of Processed Member>

The processed member 80 includes a first substrate F1, the first separation layer F2 on the first substrate F1, the first layer F3 to be separated whose one surface is in contact with the first separation layer F2, the bonding layer 30 whose one surface is in contact with the other surface of the first layer F3 to be separated, and the base layer S5 in contact with the other surface of the bonding layer 30 (see FIG. 14(A-1) and FIG. 14(A-2)).

Note that the separation starting points F3s may be formed in the vicinity of the edges of the bonding layer 30.

### <<First Substrate>>

There is no particular limitation on the first substrate F1 as long as it has heat resistance high enough to withstand a manufacturing process and a thickness and a size which can be used in a manufacturing apparatus.

For the first substrate F1, an organic material, an inorganic material, a composite material of an organic material and an inorganic material, or the like can be used.

For example, an inorganic material such as glass, ceramic, or metal, can be used for the first substrate F1.

Specifically, non-alkali glass, soda-lime glass, potash glass, crystal glass, or the like can be used for the first substrate F1.

Specifically, a metal oxide film, a metal nitride film, a metal oxynitride film, or the like can be used for the first substrate F1. For example, silicon oxide, silicon nitride, silicon oxynitride, an alumina film, or the like can be used for the first substrate F1.

Specifically, SUS, aluminum, or the like can be used for the first substrate F1.

For example, an organic material such as a resin, a resin film, or a plastic can be used for the first substrate F1.

Specifically, a resin film or a resin plate of polyester, polyolefin, polyamide, polyimide, polycarbonate, an acrylic resin, or the like can be used for the first substrate F1.

For example, a composite material such as a resin film to which a metal plate, a thin glass plate, or a film of an inorganic material is attached can be used as the first substrate F1.

For example, a composite material formed by dispersing a fibrous or particulate metal, glass, inorganic material, or the like into a resin film can be used as the first substrate F1.

For example, a composite material formed by dispersing a fibrous or particulate resin, organic material, or the like into an inorganic material can be used as the first substrate F1.

For the first substrate F1, a single-layer material or a stacked-layer material in which a plurality of layers are stacked can be used. For example, a stacked-layer material in which a base layer, an insulating layer that prevents diffusion of impurities contained in the base layer, and the like are stacked can be used for the first substrate F1.

Specifically, a stacked-layer material in which glass and one or a plurality of films that prevents diffusion of impurities contained in the glass and that are selected from a silicon oxide film, a silicon nitride film, a silicon oxynitride film, and the like are stacked can be used for the first substrate F1.

Alternatively, a stacked-layer material in which a resin and a film that prevents diffusion of impurities contained in the resin, such as a silicon oxide film, a silicon nitride film, and a silicon oxynitride film are stacked can be used for the first substrate F1.

### <<First Separation Layer>>

The first separation layer F2 is provided between the first substrate F1 and the first layer F3 to be separated. The first separation layer F2 is a layer at or near which a boundary where the first layer F3 to be separated can be separated from the first substrate F1 is formed. There is no particular limitation on the first separation layer F2 as long as it has heat resistance high enough to withstand the manufacturing process of the first layer F3 to be separated formed thereon.

For the first separation layer F2, for example, an inorganic material, an organic resin, or the like can be used.

Specifically, an inorganic material such as a metal containing an element selected from tungsten, molybdenum, titanium, tantalum, niobium, nickel, cobalt, zirconium, zinc, ruthenium, rhodium, palladium, osmium, iridium, and silicon, an alloy containing the element, or a compound containing the element can be used for the first separation layer F2.

Specifically, an organic material such as polyimide, polyester, polyolefin, polyamide, polycarbonate, or an acrylic resin can be used.

For example, a single-layer material or a stacked-layer material in which a plurality of layers are stacked can be used for the first separation layer F2.

Specifically, a material in which a layer containing tungsten and a layer containing an oxide of tungsten are stacked can be used for the first separation layer F2.

Note that the layer containing an oxide of tungsten can be formed by a method in which another layer is stacked on a layer containing tungsten. Specifically, the layer containing an oxide of tungsten may be formed by a method in which silicon oxide, silicon oxynitride, or the like is stacked on a layer containing tungsten.

The layer containing an oxide of tungsten may be formed by subjecting a surface of a layer containing tungsten to thermal oxidation treatment, oxygen plasma treatment, nitrous oxide (N₂O) plasma treatment, treatment with a solution with high oxidizing power (e.g., ozone water), or the like.

Specifically, a layer containing polyimide can be used as the first separation layer F2. The layer containing polyimide has heat resistance high enough to withstand the various manufacturing steps required to form the first layer F3 to be separated.

For example, the layer containing polyimide has heat resistance of 200° C. or higher, preferably 250° C. or higher, more preferably 300° C. or higher, still more preferably 350° C. or higher.

A film containing a monomer formed on the first substrate F1 is heated, so that a film containing polyimide obtained by condensation can be used.

### <<First Layer to be Separated>>

There is no particular limitation on the first layer F3 to be separated as long as it can be separated from the first substrate F1 and has heat resistance high enough to withstand the manufacturing process.

The boundary where the first layer F3 to be separated can be separated from the first substrate may be formed between the first layer F3 to be separated and the first separation layer F2 or may be formed between the first separation layer F2 and the first substrate F1.

In the case where the boundary is formed between the first layer F3 to be separated and the first separation layer F2, the first separation layer F2 is not included in the stack. In the case where the boundary is formed between the first separation layer F2 and the first substrate F1, the first separation layer F2 is included in the stack.

An inorganic material, an organic material, a single-layer material, a stacked-layer material in which a plurality of layers are stacked, or the like can be used for the first layer F3 to be separated.

For example, an inorganic material such as a metal oxide film, a metal nitride film, or a metal oxynitride film can be used for the first layer F3 to be separated.

Specifically, silicon oxide, silicon nitride, silicon oxynitride, an alumina film, or the like can be used for the first layer F3 to be separated.

Specifically, a resin, a resin film, plastic, or the like can be used for the first layer F3 to be separated.

Specifically, a polyimide film or the like can be used for the first layer F3 to be separated.

For example, a material having a structure in which a functional layer overlapping with the first separation layer F2 and an insulating layer that is provided between the first separation layer F2 and the functional layer and can prevent unintended diffusion of impurities which impairs the function of the functional layer are stacked can be used.

Specifically, a 0.7-mm-thick glass plate is used as the first substrate F1, and a stacked-layer material in which a 200-nm-thick silicon oxynitride film and a 30-nm-thick tungsten film are stacked in this order from the first substrate F1 side is used for the first separation layer F2. In addition, a film including a stacked-layer material in which a 600-nm-thick silicon oxynitride film and a 200-nm-thick silicon nitride film are stacked in this order from the first separation layer F2 side can be used as the first layer F3 to be separated. Note that a silicon oxynitride film refers to a film that includes more oxygen than nitrogen, and a silicon nitride oxide film refers to a film that includes more nitrogen than oxygen.

Specifically, instead of the above first layer F3 to be separated, a film including a stacked-layer material of a 600-nm-thick silicon oxynitride film, a 200-nm-thick silicon nitride film, a 200-nm-thick silicon oxynitride film, a 140-nm-thick silicon nitride oxide film, and a 100-nm-thick silicon oxynitride film stacked in this order from the first separation layer F2 side can be used as the layer to be separated.

Specifically, a stacked-layer material in which a polyimide film, a layer containing silicon oxide, silicon nitride, or the like and the functional layer are stacked in this order from the first separation layer F2 side can be used.

### <<Functional Layer>>

The functional layer is included in the first layer F3 to be separated.

For example, a functional circuit, a functional element, an optical element, a functional film, or a layer including a plurality of elements selected from these can be used as the functional layer.

Specifically, a display element that can be used in a display device, a pixel circuit driving the display element, a driver circuit driving the pixel circuit, a color filter, a moisture-proof film, and the like, and a layer including two or more selected from these can be given.

### <<Bonding Layer>>

There is no particular limitation on the bonding layer 30 as long as it bonds the first layer F3 to be separated and the base layer S5 to each other.

For the bonding layer 30, an inorganic material, an organic material, a composite material of an inorganic material and an organic material, or the like can be used.

For example, a glass layer with a melting point of 400° C. or lower, preferably 300° C. or lower, an adhesive, or the like can be used.

For example, an organic material such as a light curable adhesive, a reactive curable adhesive, a thermosetting adhesive, and/or an anaerobic adhesive can be used for the bonding layer 30.

Specifically, an adhesive containing an epoxy resin, an acrylic resin, a silicone resin, a phenol resin, a polyimide resin, an imide resin, a polyvinyl chloride (PVC) resin, a polyvinyl butyral (PVB) resin, and an ethylene vinyl acetate (EVA) resin, or the like can be used.

### <<Base Layer>>

There is no particular limitation on the base layer S5 as long as it has heat resistance high enough to withstand a manufacturing process and a thickness and a size which can be used in a manufacturing apparatus.

A material that can be used for the base layer S5 can be the same as that of the first substrate F1, for example.

### <<Separation Starting Point>>

In the processed member 80, the separation starting point F3s may be formed in the vicinity of the edges of the bonding layer 30.

The separation starting point F3s is formed by separating part of the first layer F3 to be separated, from the first substrate F1.

Part of the first layer F3 to be separated can be separated from the separation layer F2 by inserting a sharp tip into the first layer F3 to be separated, from the first substrate F1 side, or by a method using a laser or the like (e.g., a laser ablation method). Thus, the separation starting point F3s can be formed.

### <2. Structure Example of Processed Member>

The structure of the processed member that can be the stack and is different from the above is described with reference to FIG. 14(B-1) and FIG. 14(B-2).

The processed member 90 is different from the processed member 80 in that the other surface of the bonding layer 30 is in contact with one surface of the second layer S3 to be separated instead of the material S5.

Specifically, the processed member 90 includes the first substrate F1 on which the first separation layer F2 and the first layer F3 to be separated whose one surface is in contact with the first separation layer F2 are formed, the second substrate 51 on which the second separation layer S2 and the second layer S3 to be separated whose other surface is in contact with the second separation layer S2 are formed, and the bonding layer 30 whose one surface is in contact with the other surface of the first layer F3 to be separated and whose other surface is in contact with the one surface of the second layer S3 to be separated (see FIG. 14(B-1) and FIG. 14(B-2)).

### <<Second Substrate>>

As the second substrate S1, a substrate similar to the first substrate F1 can be used. Note that the second substrate S1 does not necessarily have the same structure as the first substrate F1.

### <<Second Separation Layer>>

For the second separation layer S2, a structure similar to that of the first separation layer F2 can be used. For the second separation layer S2, a structure different from that of the first separation layer F2 can also be used.

### <<Second Layer to be Separated>

As the second layer S3 to be separated, a structure similar to that of the first layer F3 to be separated can be used. For the second layer S3 to be separated, a structure different from that of the first layer F3 to be separated can also be used.

Specifically, a structure may be employed in which the first layer F3 to be separated includes a functional circuit and the second layer S3 to be separated includes a functional layer that prevents diffusion of impurities into the functional circuit.

Specifically, a structure may be employed in which the first layer F3 to be separated includes a light-emitting element that emits light to the second layer to be separated, a pixel circuit driving the light-emitting element, and a driver circuit driving the pixel circuit, and the second layer S3 to be separated includes a color filter that transmits part of light emitted from the light-emitting element and a moisture-proof film that prevents diffusion of impurities into the light-emitting element. Note that the processed member with such a structure can be used for a stack that can be used as a display device having flexibility.

This embodiment can be combined with any of the other embodiments described in this specification as appropriate.

For example, in this specification and the like, an explicit description “X and Y are connected” means that X and Y are electrically connected, X and Y are functionally connected, and X and Y are directly connected. Accordingly, without being limited to a predetermined connection relation, for example, a connection relation shown in drawings or texts, another connection relation is included.

Here, X and Y each denote an object (e.g., a device, an element, a circuit, a wiring, an electrode, a terminal, a conductive film, or a layer).

For example, in the case where X and Y are electrically connected, one or more elements that enable an electrical connection between X and Y (e.g., a switch, a transistor, a capacitor, an inductor, a resistor, a diode, a display element, a light-emitting element, or a load) can be connected between X and Y. Note that the switch is controlled to be turned on or off. That is, the switch is conducting or not conducting (is turned on or off) to determine whether current flows therethrough or not. Alternatively, the switch has a function of selecting and changing a current path.

For example, in the case where X and Y are functionally connected, one or more circuits that enable functional connection between X and Y (e.g., a logic circuit (e.g., an inverter, a NAND circuit, or a NOR circuit); a signal converter circuit (e.g., a D/A converter circuit, an A/D converter circuit, or a gamma correction circuit); a potential level converter circuit (e.g., a power supply circuit (e.g., a step-up circuit or a step-down circuit) or a level shifter circuit for changing the potential level of a signal); a voltage source; a current source; a switching circuit; an amplifier circuit (e.g., a circuit that can increase signal amplitude, the amount of current, or the like, an operational amplifier, a differential amplifier circuit, a source follower circuit, and a buffer circuit); a signal generation circuit; a memory circuit; or a control circuit) can be connected between X and Y. For example, even when another circuit is interposed between X and Y, X and Y are functionally connected if a signal output from X is transmitted to Y.

Note that in this specification and the like, an explicit description “X and Y are connected” means that X and Y are electrically connected (i.e., the case where X and Y are connected with another element or circuit provided therebetween), X and Y are functionally connected (i.e., the case where X and Y are functionally connected with another circuit provided therebetween), and X and Y are directly connected (i.e., the case where X and Y are connected without another element or circuit provided therebetween). That is, the explicit expression “X and Y are electrically connected” is the same as the explicit simple expression “X and Y are connected”.

Note that, for example, the case where a source (or a first terminal or the like) of a transistor is electrically connected to X through (or not through) Z1 and a drain (or a second terminal or the like) of the transistor is electrically connected to Y through (or not through) Z2, or the case where a source (or a first terminal or the like) of a transistor is directly connected to a part of Z1 and another part of Z1 is directly connected to X while a drain (or a second terminal or the like) of the transistor is directly connected to a part of Z2 and another part of Z2 is directly connected to Y, can be expressed by using any of the following expressions.

The expressions include, for example, “X, Y, a source (or a first terminal or the like) of a transistor, and a drain (or a second terminal or the like) of the transistor are electrically connected to each other, and X, the source (or the first terminal or the like) of the transistor, the drain (or the second terminal or the like) of the transistor, and Y are electrically connected to each other in this order”, “a source (or a first terminal or the like) of a transistor is electrically connected to X, a drain (or a second terminal or the like) of the transistor is electrically connected to Y, and X, the source (or the first terminal or the like) of the transistor, the drain (or the second terminal or the like) of the transistor, and Y are electrically connected to each other in this order”, and “X is electrically connected to Y through a source (or a first terminal or the like) and a drain (or a second terminal or the like) of a transistor, and X, the source (or the first terminal or the like) of the transistor, the drain (or the second terminal or the like) of the transistor, and Y are provided to be connected in this order”. When the connection order in a circuit configuration is defined by an expression similar to the above examples, a source (or a first terminal or the like) and a drain (or a second terminal or the like) of a transistor can be distinguished from each other to specify the technical scope. Note that these expressions are only examples and there is no limitation to the expressions. Here, X, Y, Z1, and Z2 each denote an object (e.g., a device, an element, a circuit, a wiring, an electrode, a terminal, a conductive film, and a layer).

Note that a content (or may be part of the content) described in one embodiment may be applied to, combined with, or replaced by a different content (or may be part of the different content) described in the embodiment and/or a content (or may be part of the content) described in one or a plurality of different embodiments.

Note that in each embodiment, a content described in the embodiment is a content described with reference to a variety of diagrams or a content described with a text described in this specification.

Note that by combining a diagram (or may be part thereof) illustrated in one embodiment with another part of the diagram, a different diagram (or may be part thereof) illustrated in the embodiment, and/or a diagram (or may be part thereof) illustrated in one or a plurality of different embodiments, much more diagrams can be formed.

Note that contents that are not specified in any drawing or text in the specification can be excluded from one embodiment of the invention. Alternatively, when the range of a value that is defined by the maximum and minimum values is described, part of the range is appropriately narrowed or part of the range is removed, whereby one embodiment of the invention excluding part of the range can be constituted. In this manner, it is possible to specify the technical scope of one embodiment of the present invention so that a conventional technology is excluded, for example.

As a specific example, a diagram of a circuit including a first transistor to a fifth transistor is illustrated. In that case, it can be specified that the circuit does not include a sixth transistor in the invention. It can be specified that the circuit does not include a capacitor in the invention. It can be specified that the circuit does not include a sixth transistor with a particular connection structure in the invention. It can be specified that the circuit does not include a capacitor with a particular connection structure in the invention. For example, it can be specified that a sixth transistor whose gate is connected to a gate of the third transistor is not included in the invention. For example, it can be specified that a capacitor whose first electrode is connected to the gate of the third transistor is not included in the invention.

As another specific example, the description of a value, “a voltage is preferably higher than or equal to 3 V and lower than or equal to 10 V” is given. In that case, for example, it can be specified that the case where the voltage is higher than or equal to −2 V and lower than or equal to 1 V is excluded from one embodiment of the invention. For example, it can be specified that the case where the voltage is higher than or equal to 13 V is excluded from one embodiment of the invention. Note that, for example, it can be specified that the voltage is higher than or equal to 5 V and lower than or equal to 8 V in the invention. For example, it can be specified that the voltage is approximately 9 V in the invention. For example, it can be specified that the voltage is higher than or equal to 3 V and lower than or equal to 10 V but is not 9 V in the invention. Note that even when the description “a value is preferably in a certain range” or “a value preferably satisfies a certain condition” is given, the value is not limited to the description. In other words, a description of a value that includes a term “preferable”, “preferably”, or the like does not necessarily limit the value.

As another specific example, the description “a voltage is preferably 10 V” is given. In that case, for example, it can be specified that the case where the voltage is higher than or equal to −2 V and lower than or equal to 1 V is excluded from one embodiment of the invention. For example, it can be specified that the case where the voltage is higher than or equal to 13 V is excluded from one embodiment of the invention.

As another specific example, the description “a film is an insulating film” is given to describe a property of a material. In that case, for example, it can be specified that the case where the insulating film is an organic insulating film is excluded from one embodiment of the invention. For example, it can be specified that the case where the insulating film is an inorganic insulating film is excluded from one embodiment of the invention. For example, it can be specified that the case where the insulating film is a conductive film is excluded from one embodiment of the invention. For example, it can be specified that the case where the insulating film is a semiconductor film is excluded from one embodiment of the invention.

As another specific example, the description of a stacked-layer structure, “a film is provided between an A film and a B film” is given. In that case, for example, it can be specified that the case where the film is a layered film of four or more layers is excluded from the invention. For example, it can be specified that the case where a conductive film is provided between the A film and the film is excluded from the invention.

Note that various people can implement one embodiment of the invention described in this specification and the like. However, different people may be involved in the implementation of the embodiment of the invention. For example, in the case of a transmission/reception system, the following case is possible: Company A manufactures and sells transmitting devices, and Company B manufactures and sells receiving devices. As another example, in the case of a light-emitting device including a transistor and a light-emitting element, the following case is possible: Company A manufactures and sells semiconductor devices including transistors, and Company B purchases the semiconductor devices, provides light-emitting elements for the semiconductor devices, and completes light-emitting devices.

In such a case, one embodiment of the invention can be constituted so that a patent infringement can be claimed against each of Company A and Company B. In other words, one embodiment of the invention can be constituted so that only Company A implements the embodiment, and another embodiment of the invention can be constituted so that only Company B implements the embodiment. One embodiment of the invention with which a patent infringement suit can be filed against Company A or Company B is clear and can be regarded as being disclosed in this specification or the like. For example, in the case of a transmission/reception system, even when this specification or the like does not include a description of the case where a transmitting device is used alone or the case where a receiving device is used alone, one embodiment of the invention can be constituted by only the transmitting device and another embodiment of the invention can be constituted by only the receiving device. Those embodiments of the invention are clear and can be regarded as being disclosed in this specification or the like. Another example is as follows: in the case of a light-emitting device including a transistor and a light-emitting element, even when this specification or the like does not include a description of the case where a semiconductor device including the transistor is used alone or the case where a light-emitting device including the light-emitting element is used alone, one embodiment of the invention can be constituted by only the semiconductor device including the transistor and another embodiment of the invention can be constituted by only the light-emitting device including the light-emitting element. Those embodiments of the invention are clear and can be regarded as being disclosed in this specification or the like.

Note that in this specification and the like, it may be possible for those skilled in the art to constitute one embodiment of the invention even when portions to which all the terminals of an active element (e.g., a transistor or a diode), a passive element (e.g., a capacitor or a resistor), and the like are connected are not specified. In other words, one embodiment of the invention is clear even when connection portions are not specified. Further, in the case where a connection portion is disclosed in this specification and the like, it can be determined that one embodiment of the invention in which a connection portion is not specified is disclosed in this specification and the like, in some cases. In particular, in the case where the number of portions to which the terminal is connected may be more than one, it is not necessary to specify the portions to which the terminal is connected. Therefore, it may be possible to constitute one embodiment of the invention by specifying only portions to which some of terminals of an active element (e.g., a transistor or a diode), a passive element (e.g., a capacitor or a resistor), and the like are connected.

Note that in this specification and the like, it may be possible for those skilled in the art to specify the invention when at least the connection portion of a circuit is specified. Alternatively, it may be possible for those skilled in the art to specify the invention when at least a function of a circuit is specified. In other words, when a function of a circuit is specified, one embodiment of the present invention is clear. Moreover, it can be determined that one embodiment of the present invention whose function is specified is disclosed in this specification and the like. Therefore, when a connection portion of a circuit is specified, the circuit is disclosed as one embodiment of the invention even when a function is not specified, and one embodiment of the invention can be constituted. Alternatively, when a function of a circuit is specified, the circuit is disclosed as one embodiment of the invention even when a connection portion is not specified, and one embodiment of the invention can be constituted.

Note that in this specification and the like, part of a diagram or text described in one embodiment can be taken out to constitute one embodiment of the invention. Thus, in the case where a diagram or text related to a certain portion is described, the contents taken out from part of the diagram or the text are also disclosed as one embodiment of the invention, and one embodiment of the invention can be constituted. The embodiment of the present invention is clear. Therefore, for example, in a diagram or text in which one or more active elements (e.g., transistors or diodes), wirings, passive elements (e.g., capacitors or resistors), conductive layers, insulating layers, semiconductor layers, organic materials, inorganic materials, components, devices, operating methods, manufacturing methods, or the like are described, part of the diagram or the text is taken out, and one embodiment of the invention can be constituted. For example, from a circuit diagram in which N circuit elements (e.g., transistors or capacitors; N is an integer) are provided, it is possible to take out M circuit elements (e.g., transistors or capacitors; M is an integer, where M<N) and constitute one embodiment of the invention. For another example, it is possible to take out M layers (M is an integer, where M<N) from a cross-sectional view in which N layers (N is an integer) are provided and constitute one embodiment of the invention. For another example, it is possible to take out M elements (M is an integer, where M<N) from a flow chart in which N elements (N is an integer) are provided and constitute one embodiment of the invention. For another example, it is possible to take out some given elements from a sentence “A includes B, C, D, E, or F” and constitute one embodiment of the invention, for example, “A includes B and E”, “A includes E and F”, “A includes C, E, and F”, or “A includes B, C, D, and E”.

Note that in the case where at least one specific example is described in a diagram or text described in one embodiment in this specification and the like, it will be readily appreciated by those skilled in the art that a broader concept of the specific example can be derived. Therefore, in the diagram or the text described in one embodiment, in the case where at least one specific example is described, a broader concept of the specific example is disclosed as one embodiment of the invention, and one embodiment of the invention can be constituted. The embodiment of the present invention is clear.

Note that in this specification and the like, what is illustrated in at least a diagram (which may be part thereof) is disclosed as one embodiment of the invention, and one embodiment of the invention can be constituted. Therefore, when certain contents are described in a diagram, the contents are disclosed as one embodiment of the invention even when the contents are not described with text, and one embodiment of the invention can be constituted. In a similar manner, part of a diagram, which is taken out from the diagram, is disclosed as one embodiment of the invention, and one embodiment of the invention can be constituted. The embodiment of the present invention is clear.

### REFERENCE NUMERALS

10 sensor
10B sensor
10U sensor unit
11 electrode
12 electrode
13 insulating layer
14 window portion
16 base layer
16a barrier film
16b base layer
16c resin layer
17 base layer
17p protective layer
19 sensor circuit
30 bonding layer
31 adhesive layer
32 adhesive layer
41 support
41b support
42 support
42b support
48 mask
49 solvent
80 processed member
80a remaining portion
80b surface layer
81 stack
90 processed member
90a remaining portion
90b surface layer
91 stack
91a remaining portion
91s separation starting point
92 stack
92c stack
92d stack
99 nozzle
102 substrate
104a gate electrode
106 insulating film
107 insulating film
108 insulating film
110 oxide semiconductor film
112 conductive film
112a electrode
112b electrode
114 insulating film
116 insulating film
118 insulating film
120 insulating film
122a conductive film
122b conductive film
122c gate electrode
142a opening portion
142e opening portion
151 transistor
200 input device
500 input/output device
501 display portion
502 pixel
502B sub-pixel
502G sub-pixel
502R sub-pixel
502t transistor
503c capacitor
503s signal line driver circuit
503t transistor
510 base layer
510a barrier film
510b base layer
510c resin layer
511 wiring
519 terminal
521 insulating film
528 partition
550R light-emitting element
560 sealant
567p anti-reflective layer
580R light-emitting module
K01 housing
K02 hinge
K10 arithmetic device
K10A antenna
K10B battery
K20 input/output device
K30 display portion
K31 region
K40 input device
K45 button
K100 data processing device
C sensor element
FPC1 flexible printed substrate
FPC2 flexible printed substrate
M1 transistor
M2 transistor
M3 transistor
M4 transistor
SW1 switch
SW2 switch
OUT terminal
VPO wiring
BR wiring
G1 scan line
CS wiring
DL signal line
RES wiring
VRES wiring
VPI wiring
T1 period
T2 period
T3 period
U1 period
U2 period
F1 substrate
F2 separation layer
F3 layer to be separated
F3b conductive layer
F3s separation starting point
S1 substrate
S2 separation layer
S3 layer to be separated
S5 base layer

This application is based on Japanese Patent Application serial no. 2014-045249 filed with the Japan Patent Office on Mar. 7, 2014, the entire contents of which are hereby incorporated by reference.

1. A sensor comprising:
a window portion transmitting visible light;
a sensor element having a light transmitting property and overlapping with the window portion;
a sensor circuit electrically connected to the sensor element; and
a flexible base layer supporting the sensor element and the sensor circuit,
wherein the sensor element comprises a flexible insulating layer, and a first electrode and a second electrode between which the insulating layer is interposed, and
wherein the sensor circuit supplies a sensor signal on the basis of a change in a capacitance of the sensor element.

2. The sensor according to claim 1, wherein the sensor element contains a silicone gel in the insulating layer and can be folded at a radius of curvature greater than or equal to 1 mm.

3. The sensor according to claim 1,
wherein the sensor circuit comprises:
a first transistor comprising a gate electrically connected to the first electrode of the sensor element and a first electrode electrically connected to a wiring through which a ground potential can be supplied;
a first switch comprising a control terminal electrically connected to a wiring through which a selection signal can be supplied, a first terminal electrically connected to a second electrode of the first transistor, and a second terminal electrically connected to a wiring through which the sensor signal can be supplied; and
a second switch comprising a control terminal electrically connected to the wiring through which a reset signal can be supplied, a first terminal electrically connected to the first electrode of the sensor element, and a second terminal electrically connected to the wiring through which the ground potential can be supplied.

4. An input device comprising:
a plurality of sensor units arranged in a matrix;
scan lines to which the plurality of sensor units placed along a row direction are electrically connected;
signal lines to which the plurality of sensor units placed along a column direction are electrically connected; and
a flexible base layer on which the sensor units, the scan lines, and the signal lines are placed,
wherein the sensor unit comprises a window portion transmitting visible light, a sensor element overlapping with the window portion, and a sensor circuit electrically connected to the sensor element,
wherein the sensor element comprises a flexible insulating layer, and a first electrode and a second electrode between which the insulating layer is interposed,
wherein the sensor circuit is supplied with a selection signal and supplies a sensor signal on the basis of a change in a capacitance of the sensor element,
wherein the selection signal can be supplied through the scan lines, and
wherein the signal lines can be supplied with the sensor signal.

5. The input device according to claim 4, wherein the sensor element contains a silicone gel in the insulating layer and can be folded at a radius of curvature greater than or equal to 1 mm.

6. The input device according to claim 4,
wherein the sensor circuit comprising:
a first transistor comprising a gate electrically connected to a first electrode of the sensor element and a first electrode electrically connected to a wiring through which a ground potential can be supplied;
a first switch comprising a control terminal electrically connected to a wiring through which the selection signal can be supplied, a first terminal electrically connected to a second electrode of the first transistor, and a second terminal electrically connected to a wiring through which the sensor signal can be supplied; and
a second switch comprising a control terminal electrically connected to a wiring through which a reset signal can be supplied, a first terminal electrically connected to the first electrode of the sensor element, and a second terminal electrically connected to the wiring through which the ground potential can be supplied.

7. The input device according to claim 4, wherein an area of the second electrode of the sensor element is 10 times or more as large as a sum of areas of the first electrodes included in the plurality of sensor elements electrically connected to one signal line.

8. An input/output device comprising:
a flexible input device comprising:
a plurality of sensor units that comprise window portions transmitting visible light and are arranged in a matrix;
scan lines to which the plurality of sensor units placed along a row direction are electrically connected;
signal lines to which the plurality of sensor units placed along a column direction are electrically connected; and
a first flexible base layer supporting the plurality of sensor units, the scan lines, and the signal lines; and
a display portion comprising a plurality of pixels that are arranged in a matrix and overlap with the window portions and a second flexible base layer supporting the pixels,
wherein the sensor unit comprises a sensor element overlapping with the window portion and a sensor circuit electrically connected to the sensor element,
wherein the sensor element comprises a flexible insulating layer, and a first electrode and a second electrode between which the insulating layer is interposed,
wherein the sensor circuit is supplied with a selection signal and supplies a sensor signal on the basis of a change in a capacitance of the sensor element,
wherein the selection signal can be supplied through the scan lines,
wherein the sensor signal can be supplied through the signal lines, and
wherein the sensor circuit is placed so as to overlap with gaps between the plurality of window portions.

9. The input/output device according to claim 8, further comprising a coloring layer between a sensor unit and a pixel.
